(19) United States
(12) Patent Application Publication
(10) Pub. No.: US 2008/0032738 A1
(43) Pub. Date: Feb. 7, 2008

(54) Portable wireless network

(75) Inventors: Monty Boyer, Saratoga, CA (US); Gavin Peacock, Walnut Creek, CA (US); Douglas Anderson, Sunnyvale, CA (US); Rich Karstens, Lake Forest Park, WA (US); Ryan Robertson, Seattle, WA (US); Chris Robertson, Sammamish, WA (US); David Kammer, Seattle, WA (US); Kenneth D. Comstock, Cupertino, CA (US); Yoon K. Wong, Redwood City, CA (US); Jason L. Hertzberg, San Carlos, CA (US); Steven C. Lemke, Sunnyvale, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/647,526

(22) Filed: Dec. 28, 2006

Related U.S. Application Data
(63) Continuation-in-part of application No. 11/365,281, filed on Feb. 28, 2006.
(63) Continuation-in-part of application No. 09/871,111, filed on May 31, 2001.
(63) Continuation-in-part of application No. 10/824,756, filed on Apr. 14, 2004, now Pat. No. 7,242,963.
Application No. 10/824,756 is a continuation of application No. 09/801,532, filed on Mar. 7, 2001, now Pat. No. 6,745,047.

(51) Int. Cl. H04M 1/72; G06F 1/16

(52) U.S. Cl. 455/556.1; 455/73

(57) ABSTRACT

Techniques to create a portable wireless network are described. A mobile computing device may comprise a first transceiver to communicate with a fixed wireless device, and a second transceiver to communicate with multiple wireless devices. The mobile computing device may also include a network access management module to manage communications between each wireless device and the fixed wireless device. Other embodiments are described and claimed.

### CROSS REFERENCE TO RELATED APPLICATIONS

This application is a continuation-in-part of application Ser. No. 11/365,281 filed Feb. 28, 2006, which is herein incorporated by reference in its entirety. This application is a continuation-in-part of application Ser. No. 09/871,111 filed May 31, 2001, which is herein incorporated by reference in its entirety. This application is a continuation-in-part of application Ser. No. 10/824,756 filed Apr. 14, 2004 which is a continuation of application Ser. No. 09/801,532 filed Mar. 7, 2001 and issued as U.S. Pat. No. 6,745,047, both of which are herein incorporated by reference in their entireties.

### BACKGROUND

Different wireless devices may have varying levels of communications resources. For example, different wireless devices may operate at different speeds or have varying operating ranges. Replicating certain communication resources across different wireless devices may not be convenient or possible under some circumstances. Therefore, there may be a need for techniques to combine or share use of communication resources provided by various devices.

The marketplace for portable computing devices has demanded increasing features, particularly relating to wireless communications. Wireless communication features provide convenience and accessibility to consumers, and improve productivity for businesses.

Currently, many wireless standards are competing in the portable computing device market. One such standard is the so-called “3G”, or next generation phone systems advanced by telecommunications carriers throughout the world. These new systems will allow cellular phones to have Internet access at broadband speeds, allowing streaming audio, video, and other data to cellular phones and other portable computing devices. Other wireless standards will be required which are affordable to end users and provide better accessibility and reliability.

One known system is a wireless communication system using radio frequencies for transmitting and receiving voice and data signals. The system includes an internal network having multiple internal communication paths and an external network communication path for linking the internal network to an external communications network. The internal network contains transceivers that allow for decentralized communication along multiple communication paths within the internal network. If the transceivers are out of range of a central call switching and delivery center, they can communicate via intermediate transceivers that relay the calls to the destination transceivers, eliminating the need for a central call switching and delivery center.

One drawback of this system is that it fails to provide an adequate method of collecting payments for airtime used. The transceivers used with this system only operate with special batteries which contain a code that matches the serial number of the transceiver in which it operates. The batteries are recharged at a special recharge station. Payment for the continued operation of the system is collected at the recharge station or in association with the recharge activity. This method of collecting payments is undesirable since it does not operate on a per-call or per-packet basis. Further, it is inconvenient to the user of the transceiver because a special recharge station must be used. Further still, it fails to provide any credit for intermediate transceivers that may be used for providing network links and/or communications.

Accordingly, what is needed is an improved wireless communication system. Further, what is needed is a wireless communication system and method that provides a credit to a network access node. Further still, what is needed is a wireless communication system and method that provides a debit to a network user node. Further yet, what is needed is a wireless communication system for use with a public telephone.

As the components required to build a computer system have reduced in size, new categories of electronic devices and computer systems have emerged. One of the new categories of computer systems is the “palmtop” computer system. A palmtop computer system is a computer that is small enough to be held in the hand of a user and can therefore be “palm-sized.” Most palmtop computer systems are used to implement various Personal Information Management (PIM) applications such as an address book, a daily organizer (calendar, datebook, etc.) and electronic notepads, to name a few. Palmtop computers with PIM software have been know as Personal Digital Assistants (PDAs). Many PDAs have a small and flat display screen associated therewith.

User convenience and device value are very important factors for portable electronic devices. Typically, portable electronic devices are employed while the user is on the run, e.g., in business meetings, on business travel, personal travel, in a vehicle, on foot, etc. Because the user may be occupied or busy while using the portable electronic device, the number of user steps or user tasks required in order to access information from an electronic device (or to store information into the electronic device) is crucial for producing a commercially successful and useful product. That is, the more difficult it is to access data from an electronic device, the less likely the user will perform those tasks to obtain the information. Likewise, the easier information is to obtain, the more likely the portable electronic device will be used to obtain that information and the more likely the portable electronic device will become a part of the user's everyday activities.

Similarly, the more useful the device, the more the device will be used and acquired. The functionality of mobile wireless devices is undergoing a transition. Mobile devices are evolving from a single application device with dedicated specific purpose communication channel (for example, a cell phone or pager), to more general-purpose devices with more flexible data communication capabilities.

More specifically, wireless technology is advancing, both in the number of options that are available for providing connectivity, and in their flexibility to provide general purpose data communication. Different technologies such as cellular technologies (e.g., CDMA, TDMA), LAN access technologies (e.g., IEEE 802.11, HomeRF) and PAN technologies (e.g., Bluetooth, IR) each address a different set of needs, and provide different set of potential services. Mobile devices are no longer also restricted to one communication channel. Modular mobile devices allow network interfaces to be attached, allowing for unlimited communications configurations. In addition, Bluetooth technology allows a single mobile device to be simultaneously in access multiple piconets through a single interface.

To facilitate mobile wireless communication, several wireless modem peripheral devices are available that can be directly connected to the serial interface port of a host computer system thereby providing wireless communication to the host computer system, e.g., a laptop computer. The serial interface on the wireless modem peripheral is reserved for this type of connection. Additionally, some cell phones having built-in modems also provide an interface that is reserved for the host computer system thereby providing wireless communication to the host computer system. However, cell phone interfaces tend to be complex and non-standard. Few computer users have the required cabling to make them work. As cellular phone functionality and wireless modem functionality are integrated into PDAs, a problem has arisen in that conventional PDAs heretofore do not offer a convenient (or any) mechanism for providing wireless communication to a host computer system using their internal resources as do conventional cell phones and wireless modem peripherals.

Accordingly, what is needed is a method and system allowing a PDA to use its internal resources to act as a peripheral device for a connected host computer system. Further, what is needed is a system and method allowing a PDA to provide wireless communication functionality to a connected host computer system using its internal wireless modem. What is also needed is such a system that does not require any additional physical connection resources (to the host computer system) that are not already present in the equipment of a conventional PDA. What is further needed is a mechanism that allows a host computer system to use a connected PDA as a wireless modem peripheral. Using such a method and system, a PDA could extend wireless functionality to a host computer system and thus increase the value of the PDA to the user. Embodiments of the present invention provide the above advantages and others not specifically mentioned above but described in the sections to follow.

The teachings hereinbelow extend to those embodiments which fall within the scope of the appended claims, regardless of whether they accomplish one or more of the above-mentioned needs.

### BRIEF DESCRIPTION OF THE DRAWINGS

FIG. 1 illustrates one embodiment of a system.

FIG. 2 illustrates one embodiment of a node.

FIG. 3 illustrates one embodiment of a radio sub-system.

FIG. 4 illustrates one embodiment of a processing sub-system.

FIG. 5 illustrates one embodiment of a logic diagram.

FIG. 6 is a system-level block diagram of a communication system illustrating several exemplary embodiments.

FIG. 7 is a flow chart of a method of crediting and/or debiting an account, according to an exemplary embodiment.

FIG. 8 is a flow chart of an accounting method, according to an exemplary embodiment.

FIG. 9 is system illustration of a palmtop or “palm sized” computer system connected to other computer systems and the Internet via a cradle device.

FIG. 10 is a top side perspective view of an exemplary palmtop computer system.

FIG. 11 is a bottom side perspective view of the exemplary palmtop computer system of FIG. 10.

FIG. 12 is a perspective top view of another embodiment of the exemplary palmtop computer system.

FIG. 13 is an exploded view of the components of an exemplary palmtop computer system of FIG. 10.

FIG. 14 is a perspective view of a cradle device for connecting a palmtop computer system to other systems via a communication interface.

FIG. 15 is a logical block diagram of an exemplary palmtop computer system in accordance with an embodiment of the present invention.

FIG. 16 illustrates a hardware diagram of a system in accordance with the present invention including a portable computer system coupled to a second or “host” computer system and providing peripheral support for the host computer system.

FIG. 17 illustrates a logical system diagram in accordance with the present invention including a portable computer system having a software bridge and coupled to a second or “host” computer system and providing peripheral support for the host computer system.

FIG. 18 is a flow diagram illustrating steps in accordance with the software bridge of one embodiment of the present invention for providing peripheral modem support for a connected host computer system.

FIG. 19 is a communication protocol diagram in accordance with one embodiment of the present invention having a PPP communication framework end-to-end.

FIG. 20 is a communication protocol diagram in accordance with one embodiment of the present invention where the internal-modem of the portable computer system performs NON-PPP to PPP translation for the PPP client.

FIG. 21 is a communication protocol diagram in accordance with one embodiment of the present invention where the software bridge of the portable computer system performs NON-PPP to PPP translation for the PPP client.

### DETAILED DESCRIPTION

According to an exemplary embodiment, a method of crediting an account of a network access node includes receiving a data signal at the network access node and forwarding the data signal wirelessly to a network user node. The method further includes providing account crediting information to an accounting system. The account crediting information represents a credit to be recorded for an account associated with the network access node.

According to another exemplary embodiment, a portable device is configured as a repeater and includes a means for receiving a data signal wirelessly and a means for forwarding the data signal wirelessly to a network access node. The portable device further includes a means for providing account crediting information to an accounting system. The account crediting information represents a credit to be recorded for an account associated with the portable device.

According to yet another exemplary embodiment, an accounting method for crediting an account associated with a network access node includes receiving a communication event message and crediting an account associated with the network access node. The communication event message includes identification data representing a network access node. The communication event message is received in response to the network access node receiving and forwarding a data signal on behalf of a network user node. The account is credited based on the communication event message.

According to yet another exemplary embodiment, a method of crediting an account associated with an access point includes receiving a data signal at the access point and forwarding the data signal wirelessly to a network user node using a wireless local area network (WLAN) communication standard. The method further includes providing account crediting information to an accounting system. The account crediting information represents a credit to be recorded for an account associated with the access point.

According to yet another exemplary embodiment, an access point includes a receive circuit, a transmit circuit, and an accounting circuit. The receive circuit is configured to receive a data signal. The transmit circuit is configured to transmit the data signal over a wireless local area network (WLAN) to a network user node. The accounting circuit is configured to provide account crediting information. The account crediting information represents a credit to be recorded for an account associated with the access point.

According to yet another exemplary embodiment, a system for crediting an account associated with a network access node includes a network access node, a network user node, and an accounting system. The network access node is configured to provide a communication link with a network. The network user node is configured to provide a wireless communication link with the network access node. The accounting system is configured to credit an account associated with the network access node based on a communication between the network user node and the network.

According to yet another exemplary embodiment, a wireless communication module for a public telephone coupled to a public switched telephone network includes a wireless local area network (WLAN) transceiver circuit configured to provide a wireless communication link between the public switched telephone network and a network user node.

A method and system are described for using a wireless enabled portable computer system as a wireless modem. The portable computer system may be a personal digital assistant (PDA) having an internal wireless modem. The internal wireless modem, e.g., GSM radio in one embodiment, contains a communication port (port2) that communicates with a processor of the portable computer system. The portable computer system also contains another communication port (port1) that is externally available for connection to a second computer system. A software bridge is provided that copies commands and/or data from the port1 over to the port2 and vice-versa.

The software bridge allows the second computer system to directly use the internal wireless modem of the portable computer system when the portable computer system is connected to the second computer system. The connection to the second computer system can be made by a wired connection (e.g., serial interface, RS232) or by a wireless connection, e.g., Bluetooth or infra-red communication. The port1 and the port2 can be serial communication ports which may be UART compliant. The PDA thus extends wireless functionality to a second computer system (e.g., a notebook) using conventional connection mechanisms for communicating with the second computer system. In one embodiment, any wirelessly enabled PDA can be placed in its cradle (which is coupled to a host computer system) and can readily be used as a wireless modem peripheral by the host computer system.

Regarding other embodiments, in the case where the second or “host” computer system is a PPP (point-to-point protocol) client and the wireless communication is not PPP compliant, the internal modem may provide translation to the PPP protocol. In this case, the processor receives PPP compliant communication. Alternatively, the software bridge may provide this translation if the internal modem provides non-PPP information to the processor.

More specifically, an exemplary embodiment includes a personal digital assistant comprising: a first communication port accessible from an external communication connector, the external communication connector for coupling with a host computer system; an internal wireless communication device configured to communicate with a second communication port that is internal to the personal digital assistant and wherein the second communication port is not directly accessible by the external communication connector; a memory; and a processor coupled to communicate with the first communication port and the second communication port and coupled to the memory, the processor operable to make the internal wireless communication device accessible to the host computer system by executing instructions stored in the memory that implement a communication bridge providing communication between the first communication port and the second communication port.

Another exemplary embodiment includes a computer system comprising: a host computer system; a portable computer system communicatively coupled to the host computer system and comprising: a first communication port directly accessible from an external communication device, the external communication device for communicating with the host computer system; an internal wireless communication device configured to communicate with a second communication port that is internal to the portable computer system and that is not directly accessible by the external communication device; a memory; and a processor coupled to communicate with the first communication port and the second communication port and coupled to the memory, the processor operable to make the internal wireless communication device accessible to the host computer system by executing instructions stored in the memory that implement a communication bridge between the first communication port and the second communication port.

Various embodiments may be directed to a mobile computing device such as a “smartphone” arranged to operate as a wireless access point for a network. Examples of a network may include any communications network capable of voice, data or multimedia communications, such as a cellular radiotelephone network, a wireless local area network (WLAN), a wireless metropolitan area network (WMAN), a wireless wide area network (WWAN), and so forth. In one embodiment, for example, a mobile computing device may include a first transceiver to communicate with a fixed wireless device operating as an access point for the network. The mobile computing device may also include a second transceiver to communicate with multiple wireless devices, such as other smartphones, cellular phones, laptops, handheld computers, desktop computers, and so forth. The mobile computing device may also comprise a network access management module to manage communications between each wireless device, and multiple wireless devices and the fixed wireless device. Other embodiments are described and claimed.

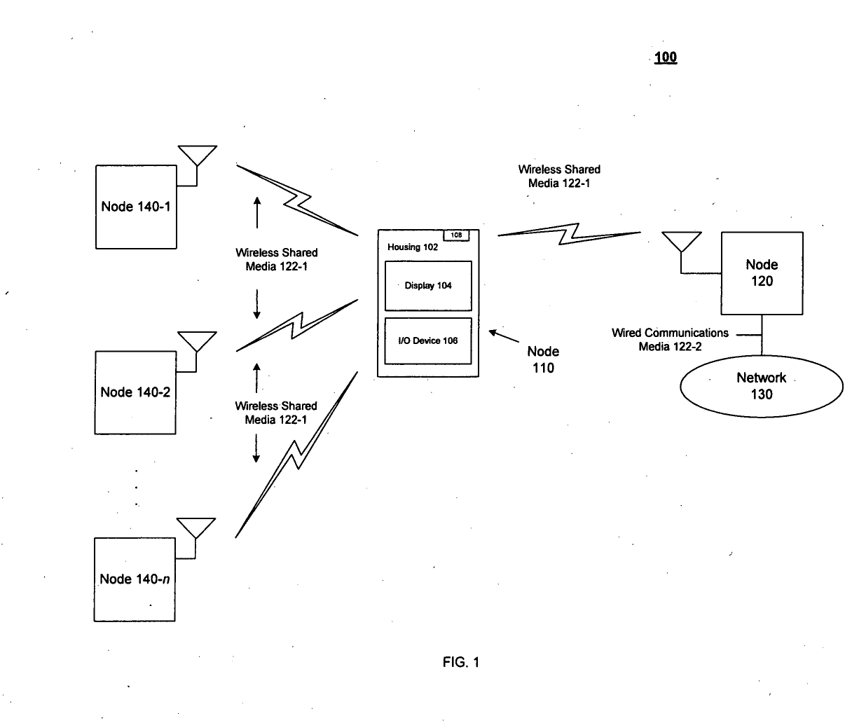

FIG. 1 illustrates one embodiment of a system. FIG. 1 illustrates a block diagram of a system 100. In one embodiment, for example, the system 100 may comprise a communication system having multiple nodes. A node may comprise any physical or logical entity for communicating information in the system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise an electronic device, such as a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smartphone, pager, one-way pager, two-way pager, messaging device, and so forth. The embodiments are not limited in this context.

In various embodiments, a node or a portion of a node may be implemented using hardware, software, or a combination of both. For example, the hardware may include electronic elements fabricated on a substrate. In various implementations, the electronic elements may be fabricated using silicon-based integrated circuit (IC) processes such as complementary metal oxide semiconductor (CMOS), bipolar, and bipolar CMOS (BiCMOS) processes, for example. Examples of hardware may include electrical or electronic elements, such as a microprocessor, an integrated circuit, a programmable logic device (PLD), a digital signal processor (DSP), a processor, a circuit, a logic gate, a register, a microprocessor, an integrated circuit, a semiconductor device, a chip, a transistor, and so forth. The embodiments are not limited in this context.

In various embodiments, a node or portions of a node may be implemented using software. The term “software” may refer to program instructions and/or data adapted for execution by a processor. The term “program instructions” may refer to an organized list of commands comprising words, values or symbols arranged in a predetermined syntax, that when executed, may cause a processor to perform a corresponding set of operations. Examples of a computer language may include C, C++, Java, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. As used herein, the term “software” may generically encompass any type of software, such as programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media, sometimes referred to herein as wireless shared media. An example of a wireless communication media may include portions of a wireless spectrum, such as one or more frequencies or frequency bands of the radio-frequency (RF) spectrum. The wireless nodes may include components and interfaces suitable for communicating information signals over the designated wireless spectrum, such as one or more antennas, radios, wireless transmitters/receivers (“transceivers”), baseband processors, amplifiers, filters, control logic, and so forth. As used herein, the term “transceiver” may be used in a very general sense to include a transmitter, a receiver, or a combination of both. The embodiments are not limited in this context.

In various embodiments, system 100 may include a wireless node 110. Wireless node 110 may comprise any node arranged with wireless capabilities. Examples of wireless node 110 may include any of the previous examples for a node as previously described. The embodiments are not limited in this context.

In one embodiment, for example, wireless node 110 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device may also include computers that are arranged to be worn by a person, such as a wrist computer, finger computer, ring computer, eyeglass computer, belt-clip computer, arm-band computer, shoe computers, clothing computers, and other wearable computers. In one embodiment, for example, mobile computing device 110 may be implemented as a smart phone capable of executing computer applications, as well as voice communications and/or data communications. Although some embodiments may be described with mobile computing device 110 implemented as a smart phone by way of example, it may be appreciated that other embodiments may be implemented using other wireless mobile computing devices as well. The embodiments are not limited in this context.

In various embodiments, mobile computing device 110 may comprise a housing 102. Housing 102 may be made of any material suitable for encapsulating some or all of the components of mobile computing device 110, such as metal, plastic, carbon fiber, polymers, and so forth. In one embodiment, housing 102 may also have a shape, size and/or form factor capable of being held with an average human hand. In one embodiment, housing 102 may also include a slot to hold a stylus for use with a touch screen. The embodiments are not limited in this context.

In various embodiments, mobile computing device 110 may comprise an input/output (I/O) device 106. I/O device 106 may comprise any suitable I/O device for entering information into a mobile computing device. Examples for I/O device 106 may include an alphanumeric keyboard, a numeric keypad, a touch pad, a touch screen, input keys, buttons, switches, rocker switches, and so forth. In one embodiment, for example, I/O device 106 may include a four-direction rocker switch with an input button in approximately the center of the rocker switch. The embodiments are not limited in this context.

In one embodiment, mobile computing device 110 may include a display 104. Display 104 may comprise any suitable display unit for displaying information appropriate for a mobile computing device. In addition, display 104 may be implemented as an additional I/O device, such as a touch screen, touch panel, touch screen panel, and so forth. Touch screens are display overlays which are implemented using one of several different techniques, such as pressure-sensitive (resistive) techniques, electrically-sensitive (capacitive) techniques, acoustically-sensitive (surface acoustic wave) techniques, photo-sensitive (infra-red) techniques, and so forth. The effect of such overlays allows a display to be used as an input device, to remove or enhance the keyboard and/or the mouse as the primary input device for interacting with content provided on display 104. The embodiments are not limited in this context.

In one embodiment, system 100 may include a wireless node 120. Wireless node 120 may comprise, for example, a fixed wireless device. In one embodiment, the fixed wireless device may comprise an access point for a network or communications system, such as a cellular radiotelephone communications system, a WLAN, a WMAN, a WWAN, and so forth. Examples for wireless node 120 may include a wireless access point, base station or node B, base station radio/transceiver, router, switch, hub, gateway, and so forth. In one embodiment, for example, wireless node 120 may comprise a base station for a cellular radiotelephone communications system. Although some embodiments may be described with wireless node 120 implemented as a base station by way of example, it may be appreciated that other embodiments may be implemented using other wireless devices as well. The embodiments are not limited in this context.

In one embodiment, system 100 may include nodes 140-1-n. Nodes 140-1-n may comprise any type of electronic device such as the examples previously recited with respect to a node in general. In one embodiment, for example, one or more nodes 140-1-n may be arranged for communications using a wireless shared media such as wireless shared media 122-1. In this case, nodes 140-1-n may include the appropriate components and interfaces suitable for communicating information signals over the available operating frequencies for wireless shared media 122-1, such as one or more antennas, radios, radio sub-systems, wireless transceivers, baseband processors, amplifiers, filters, control logic, and so forth. In one embodiment, for example, one or more nodes 140-1-n may be arranged for communications using a wired media, such as wired communications media 122-2. In this case, wired nodes 140-1-n may include the appropriate components and interfaces suitable for communicating information signals over wired communications media 122-2, such as one or more I/O adapters and/or network interface cards. In one embodiment, for example, nodes 140-1-n may comprise a combination of wired or wireless nodes. The embodiments are not limited in this context.

In one embodiment, mobile computing device 110 and nodes 140-1-n may be arranged to perform data communications using any number of different wired protocols over wired communications media 122-2. Examples of wired protocols may include IEEE 1394 (“Firewire”) protocols, universal serial bus (USB) protocols, and so forth. The embodiments are not limited in this context.

In one embodiment, mobile computing device 110 and nodes 140-1-n may be arranged to perform data communications using any number of different wireless protocols over wireless shared media 122-1. In general, mobile computing device 110 and nodes 140-1-n may use a class of wireless communications protocols that are designed for shorter range communications relative to the class of wireless communications protocols used between mobile computing device 110 and wireless node 120, for example. For example, mobile computing device 110 and nodes 140-1-n may be arranged to communicate using various WLAN protocols, including the Institute of Electrical and Electronics Engineers (IEEE) 802.xx series of protocols, such as IEEE 802.11a/b/g/n and so forth. Further examples of shorter range wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electromagnetic induction (EMI) techniques. An example of EMI techniques may include passive or active radio-frequency identification (RFID) protocols and devices. The embodiments are not limited in this context.

In one embodiment, mobile computing device 110 and wireless node 120 may comprise part of a cellular communication system. Examples of cellular communication systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, mobile computing device 110 and wireless node 120 may be arranged to perform data communications using any number of different wireless protocols over wireless shared media 122-1. In one embodiment, for example, mobile computing device 110 and wireless node 120 may use a class of wireless communications protocols that are designed for longer range communications relative to the class of wireless communications protocols used between mobile computing device 110 and nodes 140-1-n, for example. In one embodiment, for example, mobile computing device 110 and wireless node 120 may be arranged to communicate using a number of different WWAN data communication services. Examples of cellular data communication systems offering WWAN data communication services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, and so forth. In one embodiment, for example, mobile computing device 110 and wireless node 120 may also be arranged to communicate using a number of different WLAN data communication services. Examples of suitable WLAN data communication services may include the IEEE 802.xx series of protocols, such as IEEE 802.16, IEEE 802.20, and so forth. The embodiments are not limited in this respect.

In one embodiment, communication system 100 may include network 130 connected to wireless node 120 by wired communications medium 122-2. Network 130 may comprise additional nodes and connections to other networks, including a voice/data network such as the Public Switched Telephone Network (PSTN), a packet network such as the Internet, a local area network (LAN), a metropolitan area network (MAN), a wide area network (WAN), an enterprise network, a private network, and so forth. In one embodiment, for example, network 130 may be arranged to communicate information in accordance with one or more Internet protocols as defined by the Internet Engineering Task Force (IETF), such as the Transmission Control Protocol/Internet Protocol (TCP/IP), for example. Network 130 may also include other cellular radio telephone system infrastructure and equipment, such as base stations, mobile subscriber centers, central offices, and so forth. The embodiments are not limited in this context.

In general operation, the various nodes of system 100 may represent a number of different electronic devices having varying levels of communications resources. For example, mobile computing device 110 may include a GSM/GPRS transceiver, capable of communicating with a cellular radiotelephone communications system base station such as fixed wireless device 120 over a distance of several miles at operating speeds ranging between approximately 100 kilobits/second (kbps) to several megabits/second (mbps). In another example, one or more nodes 140-1-n may represent various electronic devices (e.g., laptop computer, mobile computing device, handheld computer, and so forth), each having a PAN transceiver capable of communicating information over a shorter distance (typically measured in feet) and a slower range of operating speeds (typically measured in kbps) relative to mobile computing device 110. Replicating the communication resources of mobile computing device 110 across different nodes 140-1-n may not be convenient or possible under some circumstances. Therefore, it may be desirable to share use of the more robust communication resources provided by mobile computing device 110 with the various nodes 140-1-n.

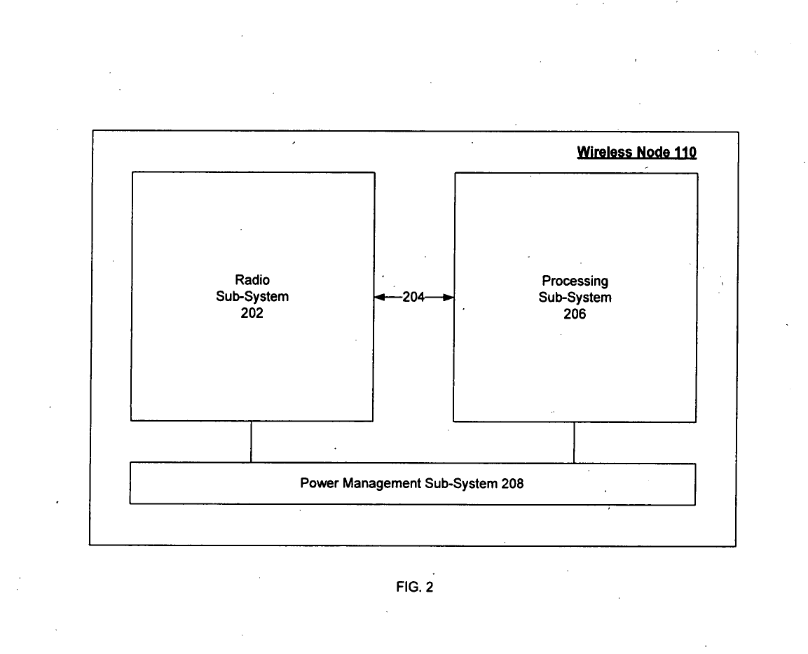

Various embodiments may address these and other problems. Various embodiments may be directed to a mobile computing device arranged to form a portable network among various nodes 140-1-n using the shorter range class of wired or wireless communications protocols, and also to operate as a wireless access point for a network such as network 130, which is normally inaccessible by the various nodes 140-1-n. In one embodiment, for example, mobile computing device 110 may include multiple transceiver and/or radio units to communicate with different classes of electronic devices. For example, mobile computing device 110 may comprise a first transceiver to communicate with a fixed wireless device operating as an access point for the network, such as wireless node 120 operating as an access point for network 130. Mobile computing device 110 may also include a second transceiver to communicate with multiple wireless devices, such as nodes 140-1-n. Mobile computing device 110 may include a network access management module to manage communications between each node 140-1-n, and between nodes 140-1-n and wireless node 120. More particularly, the network access management module may create a portable network between nodes 140-1-n and mobile computing device 110, and allow nodes 140-1-n to communicate with wireless node 120 via the more powerful or longer range communication resources of mobile computing device 110. In this manner, mobile computing device 110 may operate as a mobile and/or portable network manager and network access point for electronic devices otherwise incapable of communicating with wireless node 120 directly, or with certain other electronic devices. System 100 in general, and mobile computing device 110 in particular, may be described in more detail with reference to FIG. 2.

FIG. 2 illustrates one embodiment a node. FIG. 2 illustrates a more detailed block diagram of mobile computing device 110 as described with reference to FIG. 1. As shown in FIG. 2, mobile computing device 110 may comprise multiple elements. Although FIG. 2 shows a limited number of elements in a certain topology by way of example, it can be appreciated that more or less elements in any suitable topology may be used in mobile computing device 110 as desired for a given implementation. Furthermore, any element as described herein may be implemented using hardware, software, or a combination of both, as previously described with reference to node implementations. The embodiments are not limited in this context.

In various embodiments, mobile computing device 110 may include a radio sub-system 202 connected via bus 204 to a processing sub-system 206. Radio sub-system 202 may perform voice and data communications operations using wireless shared media 122-1 for mobile computing device 110. Processing sub-system 206 may execute software for mobile computing device 110. Bus 204 may comprise a USB or micro-USB bus and appropriate interfaces, as well as others.

In various embodiments, mobile computing device 110 may also include a power management sub-system 208. Power management sub-system 208 may manage power for mobile computing device 110, including radio sub-system 202, processing sub-system 206, and other elements of mobile computing device 110. For example, power management sub-system 208 may include one or more batteries to provide direct current (DC) power, and one or more alternating current (AC) interfaces to draw power from a standard AC main power supply. The embodiments are not limited in this context.

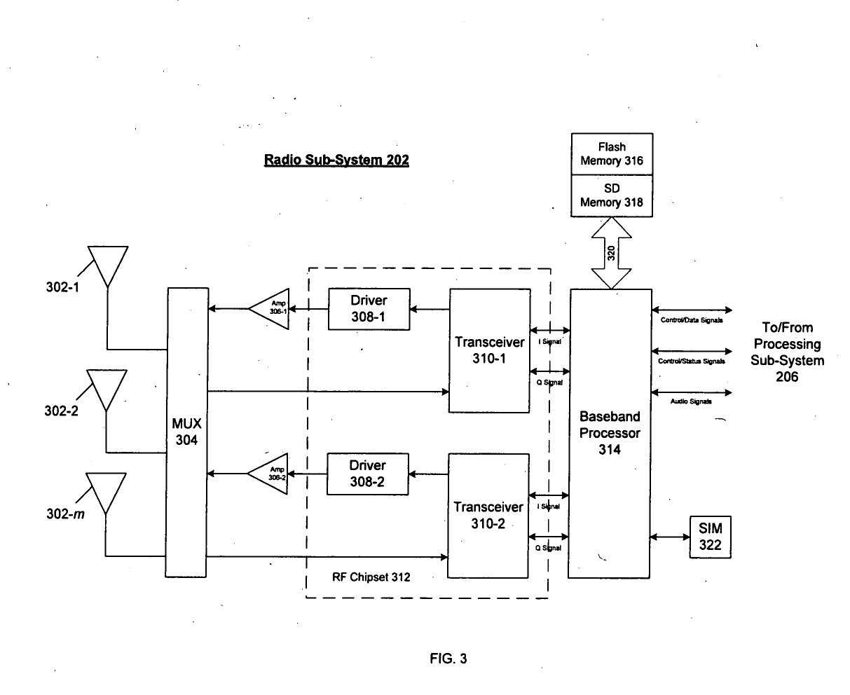

FIG. 3 illustrates one embodiment a radio sub-system. FIG. 3 illustrates a more detailed block diagram of radio sub-system 202 as described with reference to FIG. 2. Radio sub-system 202 may perform voice and data communication operations for mobile computing device 110. For example, radio sub-system 202 may be arranged to communicate voice information and control information over one or more assigned frequency bands of wireless shared media 122-1. The embodiments are not meant to be limited, however, to the example given in FIG. 3.

In various embodiments, radio sub-system 202 may include one or more antennas 302-1-m. Antenna 302-1 may be representative of, for example, antenna 108 as described with reference to FIG. 1. Antennas 302-1-m may broadcast and receive RF energy over wireless shared media 122-1. Examples for antennas 302-1-m may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. Multiple antennas may be desirable when implementing spatial diversity and/or Multiple-Input-Multiple-Output (MIMO) systems. The embodiments are not limited in this context.

In various embodiments, antennas 302-1-m may be connected to a multiplexer 304. Multiplexer 304 multiplexes signals from power amplifiers 306-1, 306-2 for delivery to antennas 302-1-m. Multiplexer 304 demultiplexes signals received from antennas 302-1-m for delivery to RF chipset 312. The embodiments are not limited in this context.

In various embodiments, multiplexer 304 may be connected to power amplifiers 306-1, 306-2. Power amplifiers 306-1, 306-2 may be used to amplify any signals to be transmitted over wireless shared media 122-1. Power amplifiers 306-1, 306-2 may work in all assigned frequency bands, such as 4 frequency bands in a quad-band system. Power amplifiers 306-1, 306-2 may also operate in various modulation modes, such as Gaussian Minimum Shift Keying (GSMK) modulation suitable for GSM systems and 8-ary Phase Shift Keying (8-PSK) modulation suitable for EDGE systems. The embodiments are not limited in this context.

In various embodiments, power amplifiers 306-1, 306-2 may be connected to an RF chipset 312. RF chipset 312 may also be connected to multiplexer 304. In one embodiment, for example, RF chipset 312 may comprise one or more transceivers in a transceiver array. For example, RF chipset 312 may include RF drivers 308-1, 308-2 each coupled to RF transceivers 310-1, 310-2, respectively. RF chipset 312 performs all of the modulation and direct conversion operations required for GMSK and 8-PSK signal types for quad-band E-GPRS radio. RF chipset 312 receives analog I & Q signals from a baseband processor 314, and converts them to an RF signal suitable for amplification by power amplifiers 306-1, 306-2. Similarly, RF chipset 312 converts the signals received from wireless shared media 122-1 via antennas 302-1-m and multiplexer 304 to analog I & Q signals to be sent to baseband processor 314. RF chipset 312 may be implemented using one or more chips as desired for a given implementation. The embodiments are not limited in this context.

In some embodiments, each transceiver 310-1, 3 10-2 may be arranged to perform data communications in accordance with a different set of wireless communications protocols and techniques. In one embodiment, for example, transceiver 310-1 may be arranged to communicate information in accordance with a first class of wireless communications protocols and techniques that are generally associated with cellular radiotelephone communication systems. Examples of the first class of protocols may include WWAN protocols, such as GSM/GPRS protocols, CDMA/1xRTT protocols, EDGE protocols, EV-DO protocols, EV-DV protocols, HSDPA protocols, and so forth. In one embodiment, for example, transceiver 310-2 may be arranged to communicate information in accordance with a second class of wireless communications protocols and techniques that are generally associated with a computer network. Examples of the second class of protocols may include WLAN protocols, such as one or more of the IEEE 802.xx series of protocols, such as IEEE 802.11a/b/g/n, IEEE 802.16, IEEE 802.20, and so forth. Other examples of the second class of protocols may include PAN protocols, Infrared protocols, Bluetooth protocols, EMI protocols including passive or active RFID protocols, and so forth. It may be appreciated that although the various protocols have been generally separated into a first class and a second class, it may be appreciated that transceivers 310-1, 310-2 may be arranged to use any type of protocol from either class as desired for a given implementation. It may also be appreciated that although RF chipset 312 is shown with two transceivers 310-1, 310-2 by way of example, RF chipset 312 may be implemented using more or less transceivers as desired for a given implementation. The embodiments are not limited in this respect.

In various embodiments, RF chipset 312 may be connected to baseband processor 314. Baseband processor 314 may perform baseband operations for radio sub-system 202. Baseband processor 314 may comprise both analog and digital baseband sections. The analog baseband section includes I & Q filters, analog-to-digital converters, digital-to-analog converters, audio circuits, and other circuits. The digital baseband section may include one or more encoders, decoders, equalizers/demodulators, GMSK modulators, GPRS ciphers, transceiver controls, automatic frequency control (AFC), automatic gain control (AGC), power amplifier (PA) ramp control, and other circuits. The embodiments are not limited in this context.

In various embodiments, baseband processor 314 may also be connected to one or more memory units via a memory bus 320. In one embodiment, for example, baseband processor 314 may be connected to a flash memory unit 316 and a secure digital (SD) memory unit 318. Memory units 316, 318 may be removable or non-removable memory. In one embodiment, for example, baseband processor 314 may use approximately 1.6 megabytes of static read-only memory (SRAM) for E-GPRS and other protocol stack needs.

In various embodiments, baseband processor 314 may also be connected to a subscriber identity module (SIM) 322. Baseband processor 314 may have a SIM interface for SIM 322. SIM 322 may comprise a smart card that encrypts voice and data transmissions and stores data about the specific user so that the user can be identified and authenticated to the network supplying voice or data communications. SIM 322 may also store data such as personal phone settings specific to the user and phone numbers. SIM 322 can be removable or non-removable. The embodiments are not limited in this context.

In various embodiments, baseband processor 314 may further include various interfaces for communicating with a host processor of processing sub-system 206. For example, baseband processor 314 may have one or more universal asynchronous receiver-transmitter (UART) interfaces, one or more control/status lines to the host processor, one or more control/data lines to the host processor, and one or more audio lines to communicate audio signals to an audio sub-system of processing sub-system 206. The embodiments are not limited in this context.

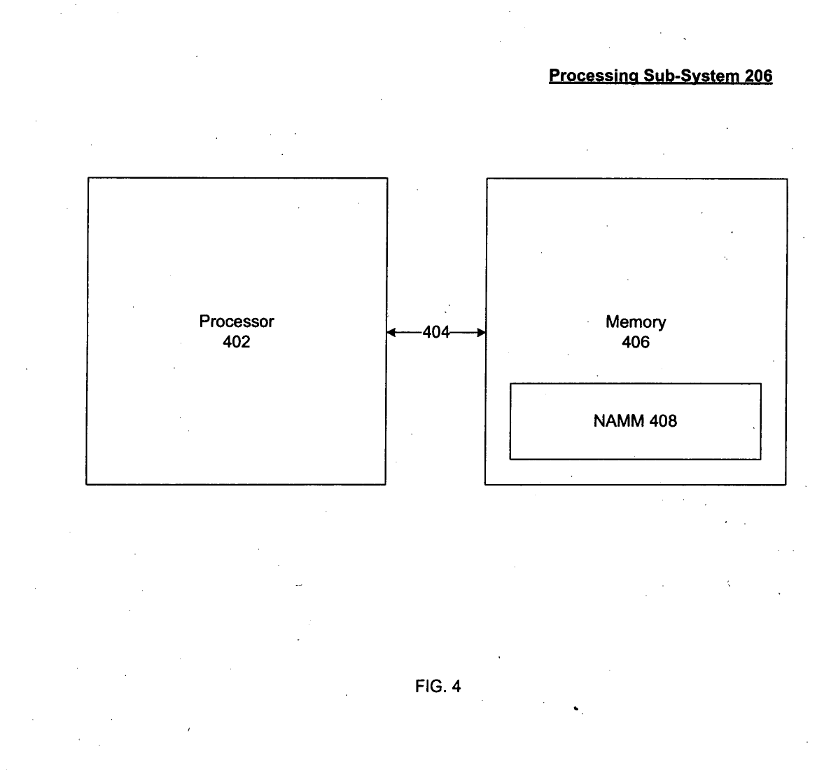

FIG. 4 illustrates one embodiment a processing sub-system. FIG. 4 illustrates a more detailed block diagram of processing sub-system 206 as described with reference to FIG. 2. Processing sub-system 206 may provide computing or processing operations for mobile computing device 110. For example, processing sub-system 206 may be arranged to execute various software programs for mobile computing device 110. Although processing sub-system 206 may be used to implement certain operations for various embodiments as software executed by a processor, it may be appreciated that the operations performed by processing sub-system 206 may also be implemented using hardware circuits or structures, or a combination of hardware and software, as desired for a particular implementation. The embodiments are not limited in this context.

In various embodiments, mobile computing device 110 may be capable of executing various types of software programs using processing sub-system 206. Software programs may be generally grouped into application programs and system programs. Application programs allow a user to accomplish one or more specific tasks. Typical applications include office suites, business software, educational software, databases, communications software, computer games, and so forth. Examples of application programs may include mail programs, web browsers, personal information manager (PIM) applications, calendar programs, scheduling programs, contact management programs, gaming programs, word processing programs, spreadsheet programs, picture management programs, video reproduction programs, audio reproduction programs, groupware programs, and so forth. Most application software has a graphical user interface (GUI) to communicate information between a device and a user. System programs assists in the running of a computer system. System programs may be directly responsible for controlling, integrating, and managing the individual hardware components of the computer system. Examples of system programs may include operating systems (OS), device drivers, programming tools, utility programs, software libraries, interfaces, program interfaces, API, and so forth.

In various embodiments, processing sub-system 206 of mobile computing device 110 may be capable of executing various types of system programs, such as different OS. In computing, an OS is the system software responsible for the direct control and management of hardware and basic system operations. Additionally, it provides a foundation upon which to run application software such as word processing programs and web browsers. Mobile computing device 110 may utilize any OS suitable for smaller form factor devices, such as a Palm OS®, Palm OS® Cobalt, Microsoft Windows® CE, Microsoft Pocket PC, Symbian OS™, Embedix OS, and others. The embodiments are not limited in this context.

In various embodiments, processing sub-system 206 may include processor 402. Processor 402 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 402 may be implemented as a general purpose processor, such as a processor made by Intel® Corporation, Santa Clara, Calif. Processor 402 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments, however, are not limited in this context.

In one embodiment, processing sub-system 206 may include memory 406 to connect to processor 402. Memory 406 may be implemented using any machine-readable or computer-readable media capable of storing data, including both volatile and non-volatile memory. For example, memory 406 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 406 may be included on the same integrated circuit as processor 402 thereby obviating the need for bus 404. Alternatively some portion or all of memory 406 may be disposed on an integrated circuit or other medium, for example a hard disk drive, that is external to the integrated circuit of processor 402, and processor 402 may access memory 406 via memory bus 404. The embodiments are not limited in this context.

In various embodiments, memory 406 may store one or more software components. A software component may refer to one or more programs, or a portion of a program, used to implement a discrete set of operations. In one embodiment, for example, memory 406 may include a software component such as network access management module (NAMM) 408. It is worthy to note that although some embodiments may describe NAMM 408 as a software program executed by processing sub-system 206, it may be appreciated that some or all of the operations of NAMM 408 may be implemented using other processors accessible by mobile computing device 110, such as baseband processor 314, for example. Furthermore, NAMM 408 may also be implemented using dedicated hardware circuits or structures, or a combination of dedicated hardware and software, as desired for a given implementation. The embodiments are not limited in this context.

In various embodiments, NAMM 408 may manage various network operations between mobile computing device 110 and wireless node 120, mobile computing device 110 and nodes 140-1-n, and between individual nodes 140-1-n. For example, NAMM 408 may perform various network management operations, such as device discovery operations, authentication operations, access management operations, security operations, encryption operations, address management operations, media access operations, coding/decoding operations, and so forth. The particular set of network management operations may vary according to a desired implementation. In essence, NAMM 408 may implement those network management operations appropriate to creating a portable network comprising mobile computing device 110 and nodes 140-1-n.

In one embodiment, for example, NAMM 408 may create a portable network by discovering any of nodes 140-1-n within communication range of mobile computing device 110. For example, transceiver 310-2 of mobile computing device 110 may be implemented as transceiver arranged to operate in accordance with a PAN wireless communication protocol, such as a Bluetooth transceiver, for example. Furthermore, one or more nodes 140-1-n may comprise wireless nodes having Bluetooth transceivers as well. In this case, mobile computing device 110 may discover the presence of nodes 140-1-n within its communication range using the discovery operations appropriate for Bluetooth devices. In another example, transceiver 310-2 of mobile computing device 110 may be implemented as a WLAN transceiver, such as an 802.11 (Wi-Fi) transceiver. In this case, mobile computing device 110 may discover the presence of any nodes 140-1-n within its communication range having 802.11 transceivers using the discovery operations appropriate for Wi-Fi enable devices. It is worthy to note that in some cases, a node 140-1-n may be connected to mobile computing device 110 via wired communications media 122-2, such as a USB or Firewire connection. In this case, discovery operations may be limited to the plug-and-play operations typically associated with a given OS. The embodiments are not limited in this context.

Once mobile computing device 110 discovers one or more nodes 140-1-n, NAMM 408 may control access to the communication resources and other resources of mobile computing device 110 by the discovered nodes 140-1-n using a number of different techniques. In a first mode of operation, for example, NAMM 408 may inform a user of the discovered nodes 140-1-n. For example, NAMM 408 may display a list of the discovered nodes 140-1-n via display 104. The user may then determine on a case-by-case basis as to whether one or more of the discovered nodes 140-1-n may initiate authentication operations to gain access to the communication resources or other resources provided by mobile computing device 110. In this manner, a user may control access to mobile computing device 110. In a second mode of operation, for example, NAMM 408 may automatically initiate authentication procedures for the discovered nodes 140-1-n. In a third mode of operation, for example, NAMM 408 may automatically initiate authentication procedures for some of the discovered nodes 140-1-n that have been previously identified as authorized devices either implicitly (e.g., prior use) or explicitly (e.g., user-defined), and present the remaining list of the discovered nodes 140-1-n to a user for permission to authenticate. The operating modes described above are provided by way of example only. Other operating modes may also be defined as desired for a given implementation. The embodiments are not limited in this context.

In addition to controlling access to mobile computing device 110, NAMM 408 may also facilitate the assignment of different sets of rights and permissions as to the level of access the discovered nodes 140-1-n may have to the communication resources or other resources of mobile computing device 110. When operating in the first mode, for example, the user may grant the discovered nodes 140-1-n different sets of rights and permissions as to the level of access the discovered nodes 140-1-n may have to the communication resources or other resources of mobile computing device 110. NAMM 408 may also automatically assign different sets of rights and permissions to some or all of the discovered nodes 140-1-n in the other operating modes as well. The embodiments are not limited in this context.

Once mobile computing device 110 discovers a node 140-1-n, NAMM 408 may optionally authenticate the discovered node. For example, a node 140-1-n may need to identify itself to mobile computing device 110, and confirm that it has authorization to access the portable network being created by mobile computing device 110. The authentication operations may include providing identity or device information to NAMM 408. Examples of device information may include a media access control (MAC) address or other hardware address. Examples of identity information may include subscriber information, such as the subscriber information typically used to access a subscriber account from a communications service provider. Examples of subscriber information may include International Mobile Subscriber Information (IMSI), which may include a subscriber name, an account number, a telephone number, subscription information, service provider information, billing information, and so forth. The subscriber information may be stored in a memory for nodes 140-1-n, such as a SIM card, for example. The type of authentication operations may vary in accordance with the communications protocol being used by mobile computing device 110 and nodes 140-1-n, such as WLAN authentication operations, PAN authentication operations, and so forth. The embodiments are not limited in this context.

When a node 140-1-n is discovered and possibly authenticated, NAMM 408 may create or form a separate data connection with each node in order to begin communicating information. In some embodiments, it may be desirable to establish a secure data connection. Establishing a secure data connection between mobile computing device 110 and nodes 140-1-n may involve certain security operations, such as creating a trusted-pair relationship, selecting a security protocol or algorithm, exchanging a private encryption key, and so forth.

Once mobile computing device has established a portable network by creating secure or unsecure data connections with nearby nodes 140-1-n using shorter range wireless or wired communications protocol techniques, nodes 140-1-n may communicate with each other and mobile computing device 110 using standard network techniques. For example, nodes 140-1-n may share files, share computing resources, share memory resources or storage resources, share application programs, and so forth. For example, the portable network may operate as a WLAN using the same media access techniques and protocols suitable for WLAN operations. In another example, nodes 140-1-n may use mobile computing device 110 as a network server, domain name server (DNS), file server, web server, storage server, and other network devices. In yet another example, nodes 140-1-n may share hardware or software resources for one or more of nodes 140-1-n. Examples of hardware resources may include a hard drive, a camera, a transceiver, a video codec, an audio codec, and so forth. Examples of software resources may include application software or system software. In still another example, one or more nodes 140-1-n may communicate with each other via mobile computing device 110. The embodiments are not limited in this context.

In some cases, it may be desirable for one or more nodes 140-1-n to communicate with wireless node 120. Nodes 140-1-n may not have, however, a communications transceiver appropriate for communication with wireless node 120, such as a GSM/GPRS transceiver, for example. In this case, nodes 140-1-n may use mobile computing device 110 to communicate information with wireless node 120. For example, assume transceiver 310-1 is a GSM/GPRS transceiver suitable for communicating with a GSM radio telephone communications system. In this case, nodes 140-1-n may communicate information to mobile computing device 110 via transceiver 310-2. Mobile computing device 110 may relay the information received from nodes 140-1-n to wireless node 120 via transceiver 310-1. In this manner, nodes 140-1-n may communicate information to wireless node 120 via mobile computing device 110. Nodes 140-1-n may also gain access to the networking resources provided by network 130, such as Internet based services, Intranet based services, and so forth.

In various embodiments, more than one node 140-1-n may attempt to simultaneously access mobile computing device 110 in an attempt to communicate with mobile computing device 110 or wireless node 120. In this case, NAMM 408 may be arranged to control access to shared wireless media 122-1 by nodes 140-1-n. For example, NAMM 408 may be arranged to implement any media access control technique typically used by cellular radiotelephone communication systems, such as a time division multiple access (TDMA) technique, a frequency division multiple access (FDMA) technique, a combination TDMA/FDMA technique, a code division multiple access (CDMA) technique, and so forth. In another example, NAMM 408 may be arranged to implement any media access control technique typically used by WLAN systems, such as carrier sense multiple access collision detection (CSMA/CD) techniques (e.g., ALOHA techniques). Less complex media access techniques may also be used, such as polling or red-robin techniques, which may decrease complexity at the cost of efficiency. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

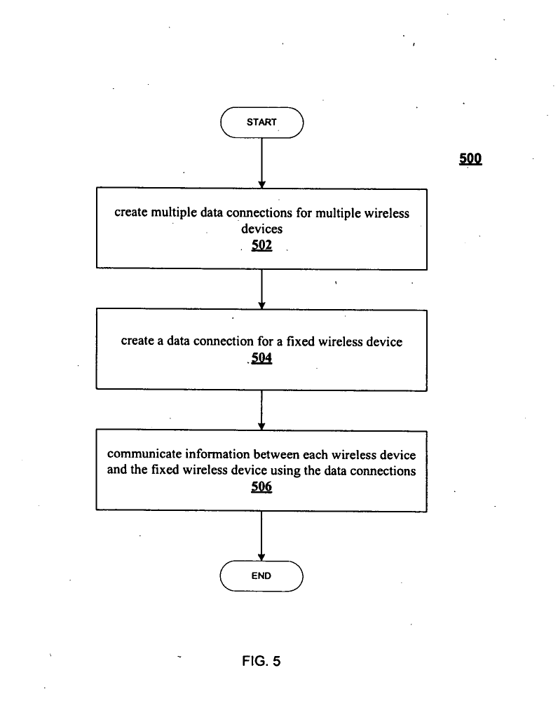

FIG. 5 illustrates one embodiment of a logic flow. FIG. 5 illustrates a logic flow 500. Logic flow 500 may be representative of the operations executed by one or more embodiments described herein, such as mobile computing device 110. As shown in logic flow 500, multiple data connections for multiple wireless devices may be created at block 502. A data connection for a fixed wireless device may be created at block 504. Information may be communicated between each wireless device and the fixed wireless device using the data connections at block 506. Furthermore, each wireless device may access or share hardware or software resources of mobile computing device 110 over the data connections. The embodiments are not limited in this context.

In one embodiment, for example, each wireless device may be discovered, and a data connection may be created for each discovered wireless device. In one embodiment, for example, each wireless device may be authenticated prior to forming a data connection for each authenticated wireless device. The embodiments are not limited in this context.

In one embodiment, for example, access to a shared wireless media may be controlled by the wireless devices to communicate information with the fixed wireless device. The embodiments are not limited in this context.

In one embodiment, for example, information may be received from one of the wireless devices. The information may be communicated to the fixed wireless device. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

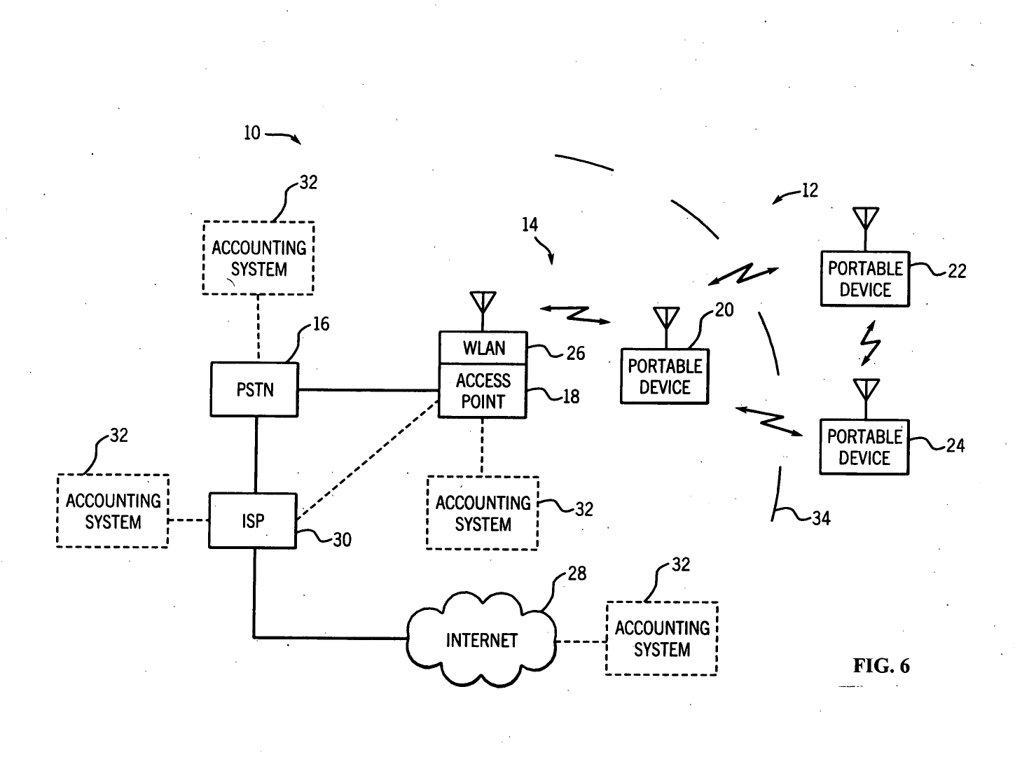

Referring first to FIG. 6, a system-level block diagram of an improved communication network 10 is illustrated, according to several exemplary embodiments. Communication system 10 includes an ad hoc network 12, an infrastructure network 14, and a public switched telephone network (PSTN) 16. Ad hoc network 12 includes two or more nodes which communicate without the use of fixed points. In this exemplary embodiment, ad hoc network 12 is a wireless local area network (WLAN) (e.g., a network communicating via the IEEE 802.11 standard protocol) made up of more than one portable device utilizing a radio frequency (RF) transceiver or infrared (IR) transceivers, such as, but not limited to, portable devices 20, 22, and 24. Infrastructure network 14 is also a WLAN network in this exemplary embodiment, and includes a fixed node with which portable nodes can communicate. The WLANs used in this exemplary embodiment have a typical signal coverage of from 50 feet of coverage area to less than 1,000 feet of coverage area, and may operate in excess of one Megabit per second. WLANs do not include cellular radio systems. The transmission may be radiated light (typically around 800 nanometer (nm) to 900 nm wavelengths) or radio frequency. Other exemplary WLAN protocols include the IEEE 802.5 token ring operation, carrier sense multiple access (CSMA), carrier sense multiple access/collision detection (CSMA/CD), IEEE 802.11A and B, IEEE 802.15, 802.16, Home RF, mesh networks, and personal area networks (PAN), such as, infrared and Bluetooth networks, and other ad hoc and/or unlicensed networks which may be developed in the future. PSTN 16 may alternatively be any type of network, such as, a cable TV network, digital subscriber line (DSL), etc. Various embodiments may utilize one or more of ad hoc network 12, infrastructure network 14, and public switched telephone network 16.

Communication system 10 includes a plurality of nodes which may perform different roles in different embodiments and may perform multiple roles over time. The nodes include portable devices 20, 22, 24 and access point 18. In particular, any of nodes 18, 20, 22 and 24 may act as network access nodes (e.g. repeaters, access points) or network user nodes, as will be described hereinbelow.

Portable devices 20, 22, 24 are computerized devices capable of communicating on one or more of networks 12, 14, 16. Portable devices 20, 22, 24 may include laptop computers, personal digital assistants, connected organizers, pagers, wireless phones, portable digital systems, or other portable devices. Thus, portable devices 20, 22, 24 can be handheld devices and can include a display, input device, (e.g., buttons, keyboard, mouse, voice-activation, etc.), audio output device (e.g., a speaker), etc. Further, portable devices 20, 22, 24 may be representative of personal area networks (PANs) in which devices within the PAN communicate with a portable device capable of accessing network 12, 14, or 16. Each device in the PAN includes a short range wireless transceiver such as Bluetooth or IR transceivers. Portable devices 20, 22, 24 may be configured to act as repeaters or access points. Repeaters receive a data signal wirelessly and forward the data signal to another node, typically wirelessly. Access points receive a data signal via a wired connection to a network, such as public switched telephone network 16, or another network (e.g., wide area network (WAN), intranet, Ethernet, DSL, cable, etc.), and forward the data signal to another node, typically wirelessly. Access point 18 may be coupled directly to an Internal service provider (ISP) 30. Access point 18 may also be a portable device. Thus, each of portable devices 20, 22, 24, and access point 18 includes one or more antennas for transmitting and/or receiving wireless data signals.

Access point 18 includes a wireless communication module 26 in this exemplary embodiment and is illustrated as an add-on structure for a public telephone. Public telephones may include any type of coin-operated phone, pay phone, or other phone accessible to or for the use of the public. Public telephones are located at various indoor and outdoor locations throughout the country and provide advantageous sites for a wireless communication module. Public telephones advantageously include a receive circuit having a connection to PSTN 16, power, billing or accounting structure, and, typically, some degree of security. Wireless communication module 26 is configured to be coupled to access point 18 and includes a WLAN transceiver circuit configured to provide a wireless communication link between PSTN 16 and portable device 20, which is a remote wireless device. Advantageously, wireless communication module 26 further includes a tamper-resistant casing surrounding the WLAN transceiver circuit which may include metal, plastic, or other materials which provide additional security to communication module 26 without unduly interfering with the wireless communication link. According to a further advantageous feature, access point 18 or wireless communication module 26 may include a high-speed connection to PSTN 16, such as, a digital subscriber line (DSL), a T1 line, etc., to improve the speed of communication between PSTN 16 and module 26. Alternatively, a communication link having a higher or lower bandwidth (e.g., a 56 kilobits per second modem, a T1 line, etc.) may be utilized.

Access point 18, acting as a network access mode providing access to PSTN 16 and/or Internet (or intranet) 28, is configured to provide data signals to portable device 20 based on data received from PSTN 16. Such data may include data from Internet 28 which is received via a data source, such as, Internet service provider (ISP) 30. In this manner, portable device 20, as a network user node, communicates with Internet 28 to send and receive data, including textual data, electronic mail, voice data, video data, and other types of data.

In an exemplary embodiment wherein access point 18 is coupled to a public telephone, many advantages are attendant. For example, because public telephones are ubiquitous in public and private areas of the United States, wide-ranging accessibility to a WLAN network is provided for network user nodes, such as, portable devices. Also, network user nodes may access content from Internet 28 or other internet protocol networks via a data source, such as, Internet service provider 30 via PSTN 16.

According to a further advantageous aspect, module 26 may be configured for handing off portable device 20 from one access point to another neighboring access point as portable device 20 travels from a range associated with access point 18 to a range associated with another nearby access point.

According to a further advantage, an accounting system 32 is provided which monitors use of access point 18 by portable device 20 and charges an account associated with portable device 20 or the user thereof, in exchange for the service provided. Thus, the user of portable device 20 may enjoy a wide coverage area accessible via WLAN protocols, and charges for use thereof (for example, on a flat-fee basis, per-usage basis, airtime basis, per-packet basis, or based on the time of day) would appear on a periodic phone bill, such as a monthly phone bill, for the use of portable device 20.

Where accounting system 32 is coupled to PSTN 16, the charges for use of access point 18 appears on a monthly telephone bill (e.g., from a local home telephone service provider) associated with the user of portable device 20. Alternatively, the charges could appear on a separate bill tied to the usage of portable device 20, ISP 30, or another billing system. Furthermore, where high-speed access is available, higher charges may be applied to such a bill when high-speed access is used compared with situations in which the access speed is slower.

As mentioned, accounting system 32 is configured to debit an account associated with portable device 20, which is a destination node of a data signal. Accounting system 32 may include software and/or hardware circuitry configured to monitor usage of access point 18 on a per-packet basis, on an airtime basis, a flat fee basis, or other debiting methods. Various parties involved in the transmission of the data signal to portable device 20 may be involved in the accounting process. As shown in FIG. 6, accounting system 32 may be resident at access point 18, and/or PSTN 16 and/or ISP 30 and/or Internet 28. Furthermore, various parts of the accounting system may be located in one or more of these locations, or other locations. For example, a company may provide an Internet-based accounting system which communicates through ISP 30 and through PSTN 16 to access point 18 in order to monitor communications between access point 18 and network user nodes and to record debit information relating to the communications. Accounting system 32 then generates billing data and sends the billing data, either via electronic mail, paper mail, or in conjunction with an existing local home telephone bill provided by a telephone company to the user of portable device 20. Alternatively, ISP 30 may provide this accounting function or some portion thereof.

According to another advantageous aspect of this exemplary embodiment, a credit is provided to an account associated with access point 18 in compensation for access point 18 acting as a network access node by providing a communication link between portable device 20 and PSTN 16. For example, access point 18 is provided at a commercial or residential establishment, either inside or outside of the establishment. The owner of the establishment is credited for use by one or more portable devices 20 of access point 18. The credit is calculated based on the data signal transmitted, and may be charged on a per-packet basis, based on usage time, on a flat fee schedule, on the time of day of the usage, or other crediting methods. The flat fee schedule may include a standard credit per call, per month, etc. The credit may be a monetary credit or non-monetary credit (e.g., frequent-flyer miles, etc.). In this way, the owner of the establishment associated with access point 18 is provided with an incentive to establish and maintain an access point and to encourage users of portable devices to communicate with the owner's access point. Other parties may also be entitled to a credit, such as, a phone company, wherein the phone company owns and operates access point 18, Internet service provider 30, wherein ISP 30 provides the data signal from Internet 28 or from another network source to access point 18, or another third party who maintains the accounting system 32. In an exemplary embodiment, for a single packet of data that portable device 20 receives from Internet 28 via access point 18 or transmits thereto, accounting system 32 debits the account of portable device 20 by one unit, and credits the one unit based on any number of crediting methods to accounts associated with access point 18, PSTN 16, ISP 30, and accounting system 32.

Depending upon the payment model, access point 18 may generate its own revenue, which may pay for the hardware and high-speed network connection. If additional credit is available due to a high usage of access point 18 by many portable devices 20, a revenue stream over and above that necessary to pay for the hardware and network connection is available for the owner of access point 18, PSTN 16, ISP 30, or other third parties. Advantageously, no one party need pay the cost of a high-speed network connection, such as DSL, but rather the cost is distributed among a number of users of portable devices 20 and/or the owner of access point 18. The owner of access point 18 may choose the amount of credit that access point 18 receives, thereby providing more or less of an incentive for wireless users of portable devices 20 to use access point 18. Network user nodes (e.g., portable device 20) can include a user interface to allow a user to view costs and the speed of different network access nodes (e.g., access point 18) within WLAN range and to select one of the network access nodes for use.

One exemplary method of utilizing such a system will now be described. An owner of a commercial or residential establishment first decides that a high-speed network connection is desired for such things as Internet access. The owner contacts an access point provider who sells, leases, or gives an access point to the owner to be located on the owner's property. The access point provider may be a telephone company, an Internet service provider, or another party. The owner then promotes the availability of high-speed Internet access and other network access to potential users having portable devices in the nearby area (since access point 18 operates via WLAN technology, the range of access point 18 is limited to the range of the WLAN protocol). Accounting system 32 then monitors usage of access point 18, and provides credits to an account associated with access point 18, and potentially other accounts. The credits may be provided on a per-packet basis, or based on another payment method. Accounting system 32 can also debit an account associated with portable device 20 equal to the total credits provided to access point 18 the other parties receiving credits. For example, ISP 30 may receive a credit sufficient to cover the line charge of the high-speed Internet access. Thus, the cost of the service to the owner of access point 18 may be reduced or eliminated. In the event that a party other than the owner provides power to access point 18, this party may also be provided with a credit in accounting system 32.

This exemplary accounting system provides credits and debits for actual usage to the owner of access point 18, which encourages owners to maintain access points and to advertise the availability of access. According to a further alternative embodiment, one or more of nodes 18 and 20-24 may be configured to query accounting system 32 before operating as an access point or repeater to transmit data signals to determine whether the node requesting access has a sufficient account balance, credit line, or established account.

In some situations, the portable device will not be within range of access point 18. For example, as illustrated in FIG. 6, a maximum range line 34 indicates the maximum range within which access point 18 can communicate via wireless communication module 26 in a reliable manner with portable devices. Maximum range line 34 may be approximately 200 feet, approximately 400 feet, or other ranges, typically less than 1,000 feet in a WLAN environment. Portable device 22 and portable device 24 are illustrated as being outside of maximum range line 34. In this situation, portable device 20 acts as a repeater to provide data signals from access point 18 to portable devices 22, 24. Thus, in this embodiment, portable device 20 is a network access node and portable device 22, 24 are network user nodes. Portable device 20 includes a receive circuit and a transmit circuit for communicating with portable devices 22, 24 and with access point 18. In response to a request from portable device 22, portable device 20 sends a return message indicating portable device 20 is available to act as a repeater and is in range of an access point or another repeater which is in range of an access point, and so forth. Portable device 22 then makes a determination based upon received signals from portable device 20 or other portable devices or access points which portable device or access point to communicate with. As mentioned, portable device 22 may include an operator interface to display charges and network speeds associated with each network access node within range and to receive a user selection of one of the network access nodes for use. In this example, portable device 22 selects portable device 20 to act as a repeater for data transmitted and/or received to/from access point 18.

Portable device 20 and/or portable device 22 further includes the function of providing account crediting information to accounting system 32 and/or providing account debiting information to accounting system 32. A communication event message is provided by one or more of nodes 18, 20, 22, 24 to accounting system 32 based on the communication of data among the nodes. A communication event message is a message including information regarding one or more communication events among the nodes. For example, portable device 22 can provide a communication event message having an identification message to portable device 20, either at the time of initiating communication, at the beginning and end of a communication, during a lengthy communication, or periodically. The identification message identifies portable device 22 uniquely and allows accounting system 32 to identify an account associated with portable device 22 for debiting. Portable device 20 may additionally provide account information in the form of an identification message uniquely representing portable device 20, wherein accounting system 32 receives the identification data for portable device 20 and recognizes this identification as associated with an account which is to receive a credit based on portable device 20 acting as a repeater. As discussed hereinabove, accounting system 32 may further provide a credit to access point 18, PSTN 16, ISP 30, a power supplier for access point 18 and/or other third parties.

The transceiver circuitry resident on portable device 20 and portable device 22 may include any type of WLAN communication circuitry. Portable device 22 may further be configured to operate in ad hoc network 12 in addition to communicating with infrastructure network 14.

Account information, including account debiting information and account crediting information, can be provided in a number of ways among portable devices 20, 22, 24, access point 18, and accounting system 32. In one exemplary embodiment, portable device 22 provides a first part of a communication event message having an identification message uniquely identifying portable device 22 to portable device 20. Portable device 20 provides the first part of the communication event message along with a second part of the communication event message including an identification message uniquely identifying portable device 20 to access point 18. Access point 18 provides a third part of the communication event message representing an identification message uniquely identifying access point 18 along with the identification messages of portable devices 20, 22 to accounting system 32. Accounting system 32 reads the communication event message, determines which identification messages correspond to accounts to be credited and which identification messages correspond to accounts to be debited and is configured to make the necessary debits and credits to the respective accounts. The communication event message can include other accounting information, such as, information regarding the number of packets transmitted, the duration of the transmission, billing information (e.g., whether billing is on a per-packet basis, on a flat-fee basis, is to be provided on a calling card, or other account information, etc.), or other necessary billing information.

Portable device 20 will consume power in acting as a repeater. Accordingly, portable device 20 may include additional batteries, or may include a power cord plugged into a conventional power outlet. Thus, portable device 20 may be a handheld device having a rechargeable battery, the device being left in a “sleep” mode while plugged into a power outlet, and being awakened by a request from portable device 22 for portable device 20 to act as a repeater. Advantageously, portable device 20 may be a laptop computer, which includes a rechargeable battery having greater power than smaller portable devices.

By allowing portable device 20 to receive credits while not being used for other purposes, an incentive is provided to use portable device 20 as a repeater for the benefit of other portable devices, such as portable devices 22, 24. Payment is provided in order to compensate portable device 20 for power drain, for usage time, etc.

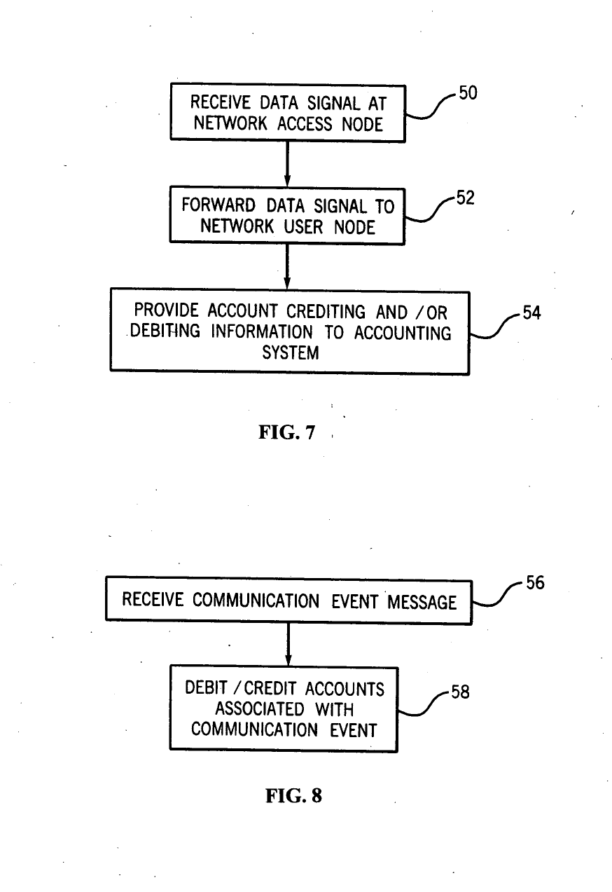

Referring now to FIG. 7, an exemplary method of crediting and/or debiting an account of a network access node will now be described. The method may be operable on a software and/or hardware system resident at one or more locations in communication system 10. For example, the method may be an application program operable on access point 18 or portable device 20 or portable devices 22, 24. At step 50, a data signal is received at the network access node. As mentioned, the network access node may be an access point or a repeater, and may be any of access point 18 or portable devices 20, 22, 24. The data signal may be digital information, voice, video, or other data signals received from a data signal source, such as ISP 30, Internet 28, or other signal sources. A data signal may be received wirelessly via ad hoc network 12 or infrastructure network 14, or may be received via a wired connection, such as, via PSTN 16.

At step 52, the data signal is forwarded wirelessly to a network user node. The network user node can be a portable device, such as, portable device 22, or can be another access point or other device. The data signal may be converted to another communication protocol, or can be communicated in a similar communication protocol to that received. The data signal can be forwarded in a wireless communication protocol, such as a WLAN protocol.

At step 54, account crediting and/or debiting information is provided to accounting system 32. As discussed, account crediting information may include a node identification message, packet information, usage time information, or other information useful to accounting system 32 in providing a credit and/or debit to the nodes of communication system 10. The account crediting and/or debiting information may be provided to accounting system 32 wirelessly, either in a separate message or along with a message containing a data signal, or may be provided periodically via a wired connection (e.g., a synchronization step), or by other steps. The account crediting information may further include a credit to ISP 30 in exchange for providing the data signal, or in exchange for the cost of a high-speed Internet connection (e.g., DSL, T1, etc.), or for other reasons.

After account crediting information has been provided to accounting system 32, accounting system 32 provides credits to network access node accounts associated with portable device 20, access point 18, and other accounts, which may be based on the forwarded data signal (e.g., based on airtime usage, per-packet charges, etc.). Accounting system 32 also provides debits to network user node accounts.

Referring now to FIG. 8, an exemplary accounting method operable in accounting system 32 will now be described. As mentioned, accounting system 32 may be a software program operable on one or more of the nodes in communication system 10.

At step 56, accounting system 32 receives a communication event message. The communication event message preferably includes identification data for each node which requires a credit or a debit. The communication event message is transmitted in response to a network access node receiving and forwarding a data signal on behalf of a network user node in this exemplary embodiment. The communication event message may be sent at the same time as the repeater function or the communication event message may be sent at the end of a period of time, such as a day, week, month, etc.

At step 58, accounting system 32 is configured to credit or debit accounts associated with the communication event message. The communication event message may further include the number of packets in the forwarded data signal, the duration of the communication event between the wireless signal provider node and the destination node, or other data useful to accounting system 32 in providing necessary credits and debits to accounts associated with the communication event.

As mentioned, the exemplary debiting and crediting methods described above may be configured to provide account adjustments (e.g., credits, debits, etc.) to accounts associated with one or more of nodes 18, 20, 22, and 24, or may be configured to provide account adjustments to accounts associated with persons (e.g., users, owners, business associations, etc.). In many cases, both a person and a node will be associated with an account. In other cases, a person may have one account associated with several nodes (or several accounts associated with one node). For example, a person owns several nodes including a portable device, a personal computer, and a vehicle, all of which include transceiver circuitry configured to communicate over one or more of networks 12, 14, and 16. Accounting system 32 can be configured to provide account adjustments to a single account associated with the person based on the use of the person's nodes. Thus, the account associated with the person is credited where any one of the person's nodes is used as a network access node and the account associated with the person is debited where any one of the person's nodes is used as a network user node. The person then may variously use one or more of the person's nodes, wherein all debits are provided to the person's single account.

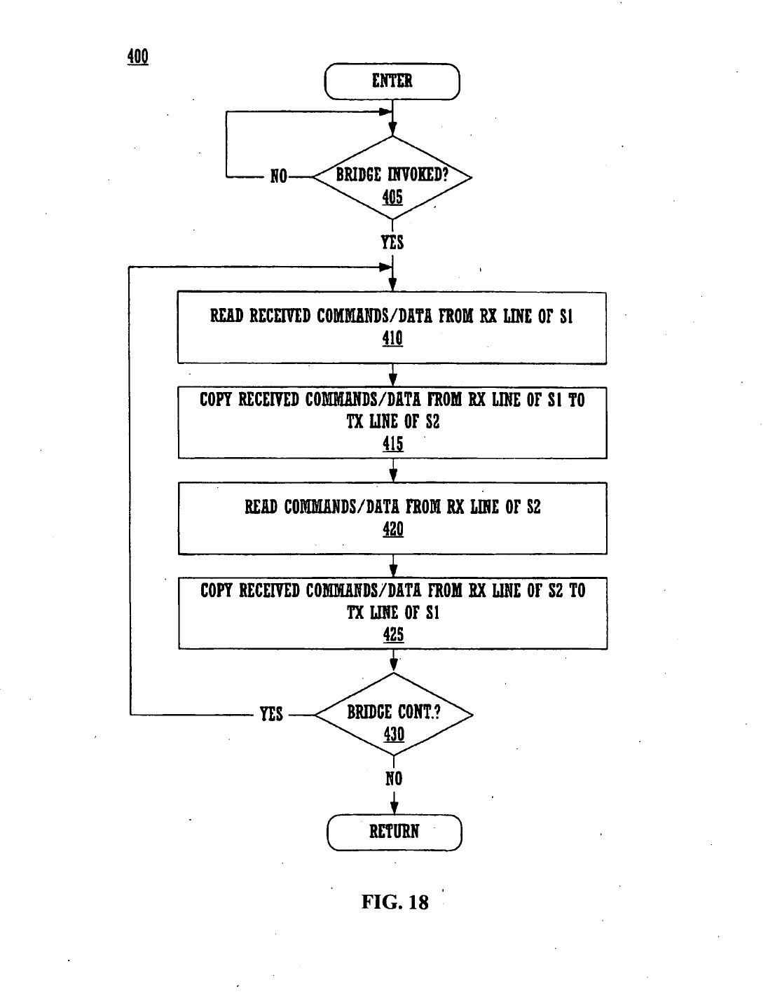

Some portions of the detailed descriptions which follow (e.g., process 400 of FIG. 18) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “checking,” “accessing” or “processing” or “computing” or “suspending” or “resuming” or “translating” or “calculating” or “determining” or “scrolling” or “displaying” or “recognizing” or “executing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes of the present invention described herein are particularly applicable to portable computer systems called personal digital assistants (PDA). These devices include, for instance, intelligent cell phones, computerized pagers and portable computer systems. Although applicable across a wide variety of platforms and devices, the present invention is described herein by example with respect to a portable or mobile computer system.

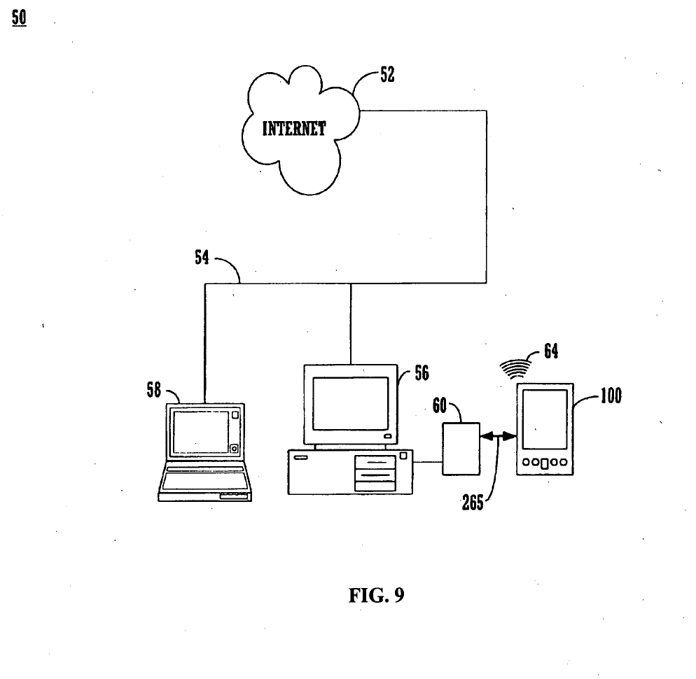

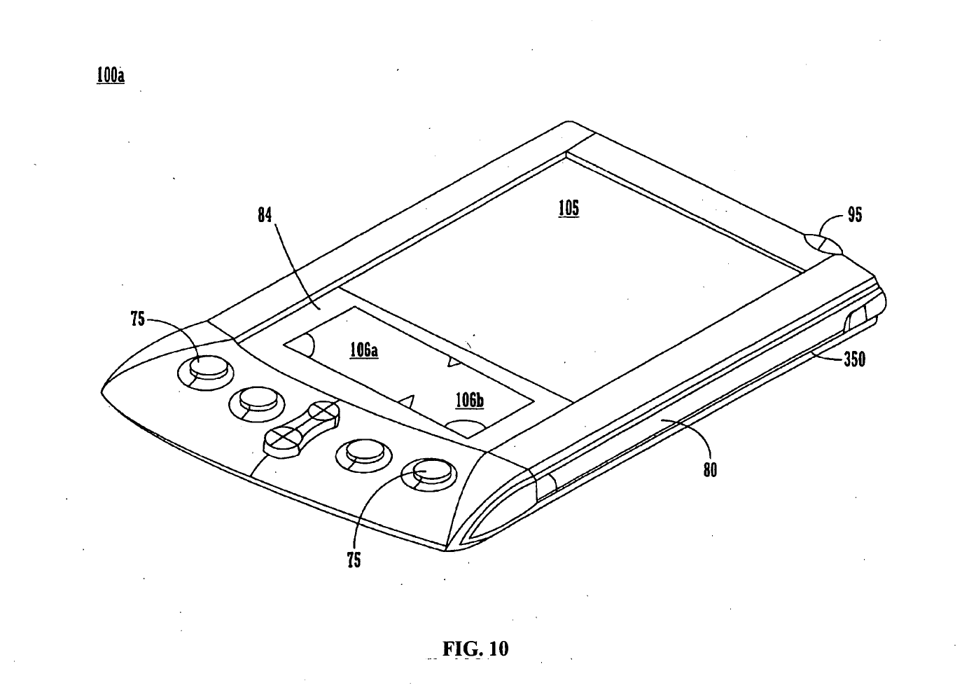

FIG. 9 illustrates an exemplary networked system 50 that can be used in conjunction with an embodiment of the present invention. System 50 is exemplary only and comprises a host computer system 56 which can either be a desktop unit as shown, or, alternatively, can be a laptop system 58. Optionally, one or more host computer systems can be used within system 50. Host computer systems 58 and 56 are shown connected to a communication bus 54, which in one embodiment can be a serial communication bus, but could be of any of a number of well known designs, e.g., a parallel bus, Ethernet Local Area Network (LAN), etc. Optionally, bus 54 (or a separate communication channel) can provide communication with the Internet 52 using a number of well known protocols.

Importantly, a communication link is also coupled to a cradle 60 (or cable dock) for receiving and initiating communication with an exemplary palmtop (“palm-sized”) portable computer system 100 over line 265. Cradle 60 provides an electrical and mechanical communication interface between the computer system 100 for two way communications. In one embodiment, the communication link including cradle 60 and line 265 is a serial communication link or can be a USB link. Computer system 100 may also contain a wireless infrared communication mechanism 64 for sending and receiving information to or from other devices. As discussed more fully below, computer system 100 also contains one or more other wireless communication mechanisms, e.g., cellular phone, Bluetooth and/or wireless LAN (e.g., IEEE 802.11), for instance, all of which can be used to establish the communication link between the portable computer system 100 and the host computer system. As described further below, embodiments of the present invention facilitate the use of the portable computer system 100 as a peripheral to the host computer system thereby leveraging the communication link between the two devices.

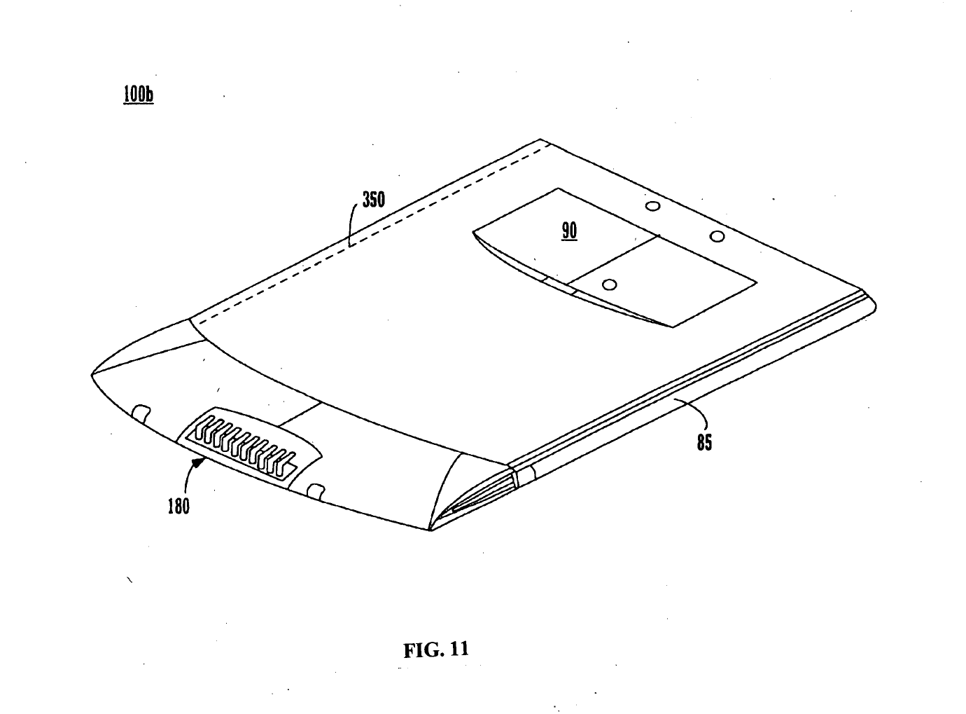

FIG. 10 is a perspective illustration of the top face 100a of one embodiment of the palmtop computer system. The top face 110a contains a display screen 105 surrounded by a bezel or cover. A removable stylus 80 is also shown. The display screen 105 contains a transparent touch screen (digitizer) able to register contact between the screen and the tip of the stylus 80. The stylus 80 can be of any material to make contact with the screen 105. As shown in FIG. 10, the stylus 80 is inserted into a receiving slot or rail 350. Slot or rail 350 acts to hold the stylus when the computer system 100a is not in use. Slot or rail 350 may contain switching devices for automatically powering down and automatically power up computer system 100a based on the position of the stylus 80. The top face 100a also contains one or more dedicated and/or programmable buttons 75 for selecting information and causing the computer system to implement functions. Other buttons (icons) can be implemented within a silk screen layer material 84 on which regions 106a and 106b reside. An exemplary on/off button 95 is also shown.

FIG. 10 also illustrates a handwriting recognition pad or “digitizer” containing two regions 106a and 106b. Region 106a is for the drawing of alpha characters therein for automatic recognition (and generally not used for recognizing numeric characters) and region 106b is for the drawing of numeric characters therein for automatic recognition (and generally not used for recognizing numeric characters). The stylus 80 is used for stroking a character within one of the regions 106a and 106b. The stroke information is then fed to an internal processor for automatic character recognition. Once characters are recognized, they are typically displayed on the screen 105 for verification and/or modification.

The digitizer 160 records both the (x, y) coordinate value of the current location of the stylus and also simultaneously records the pressure that the stylus exerts on the face of the digitizer pad. The coordinate values (spatial information) and pressure data are then output on separate channels for sampling by the processor 101 (FIG. 5). In one implementation, there are roughly 256 different discrete levels of pressure that can be detected by the digitizer 106. Since the digitizer's channels are sampled serially by the processor, the stroke spatial data are sampled “pseudo” simultaneously with the associated pressure data. The sampled data is then stored in a memory by the processor 101 (FIG. 5) for later analysis.

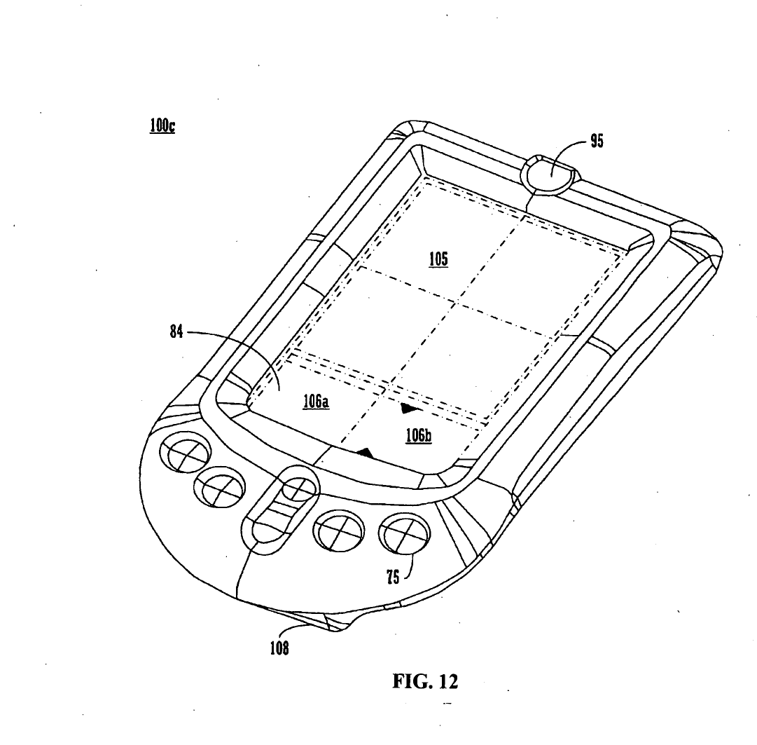

FIG. 11 illustrates the bottom side 100b of one embodiment of the palmtop computer system. An optional extendible antenna 85 is shown and also a battery storage compartment door 90 is shown. A communication interface 108 is also shown. In one embodiment of the present invention, the serial communication interface 108 is a serial communication port, but could also alternatively be of any of a number of well known communication standards and protocols, e.g., parallel, SCSI, Firewire (IEEE 1394), Ethernet, etc. In FIG. 11 is also shown the stylus receiving slot or rail 350.

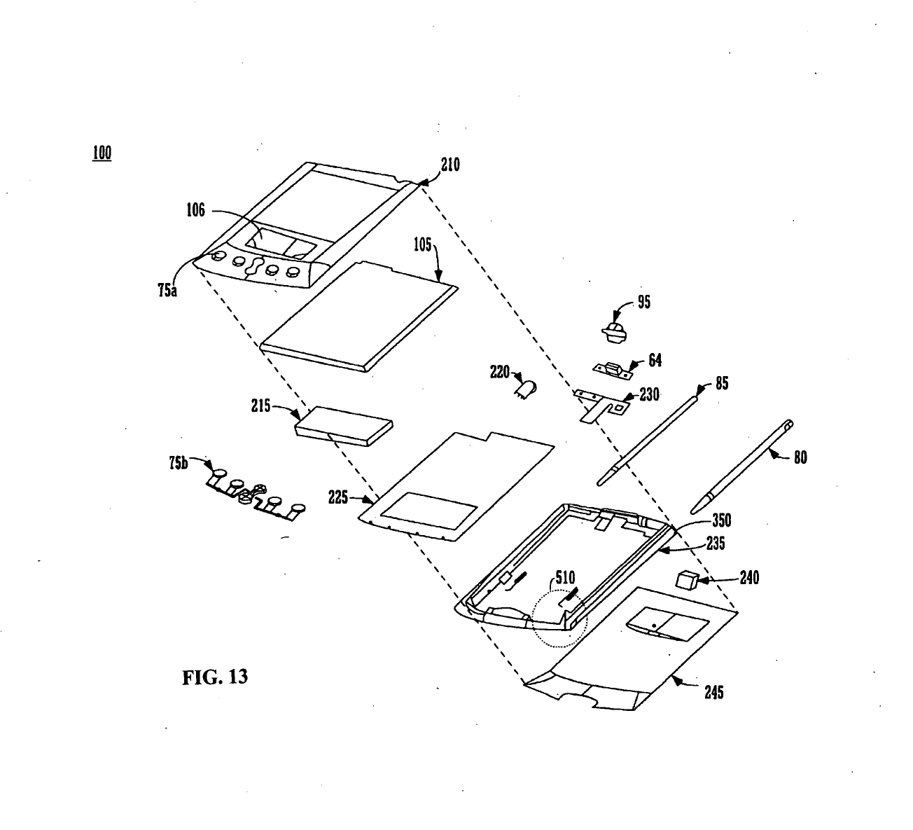

FIG. 12 illustrates a front perspective view of another implementation 100c of the palmtop computer system. As shown, the flat central area is composed of a display screen area 105 and a thin silk screen layer material portion 84. Typically, the silk screen layer material portion 84 is opaque and may contain icons, buttons, images, etc., graphically printed thereon in addition to regions 106a and 106b. The display screen area 105 and portion 84 are disposed over a digitizer.

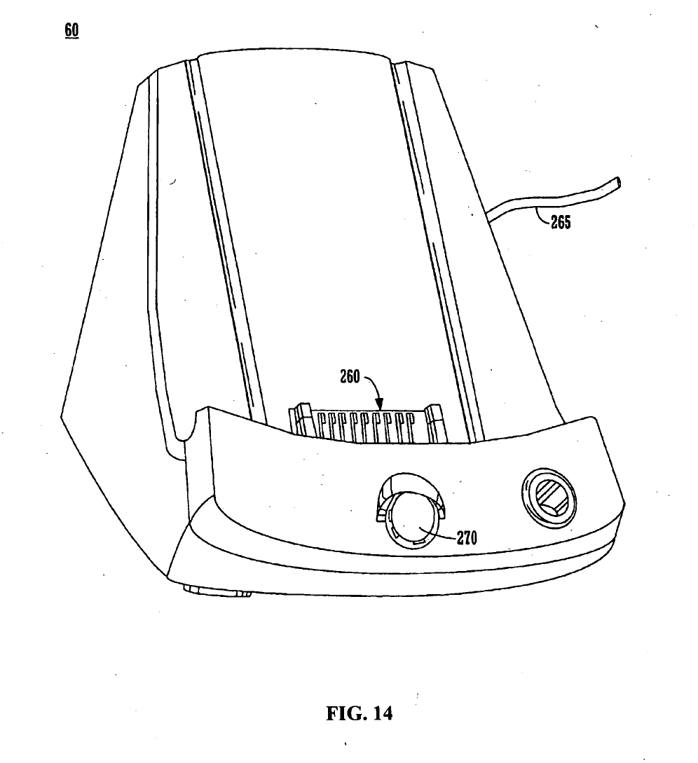

FIG. 13 is an exploded view of the exemplary palmtop computer system 100. System 100 contains a front cover 210 having an outline of region 106 and holes 75a for receiving buttons 75b. A flat panel display 105 (both liquid crystal display and touch screen) fits into front cover 210. Any of a number of display technologies can be used, e.g., LCD, FED, plasma, etc., for the flat panel display 105. In one embodiment, the display 105 is a flat panel multi-mode display capable of both monochrome and color display modes.

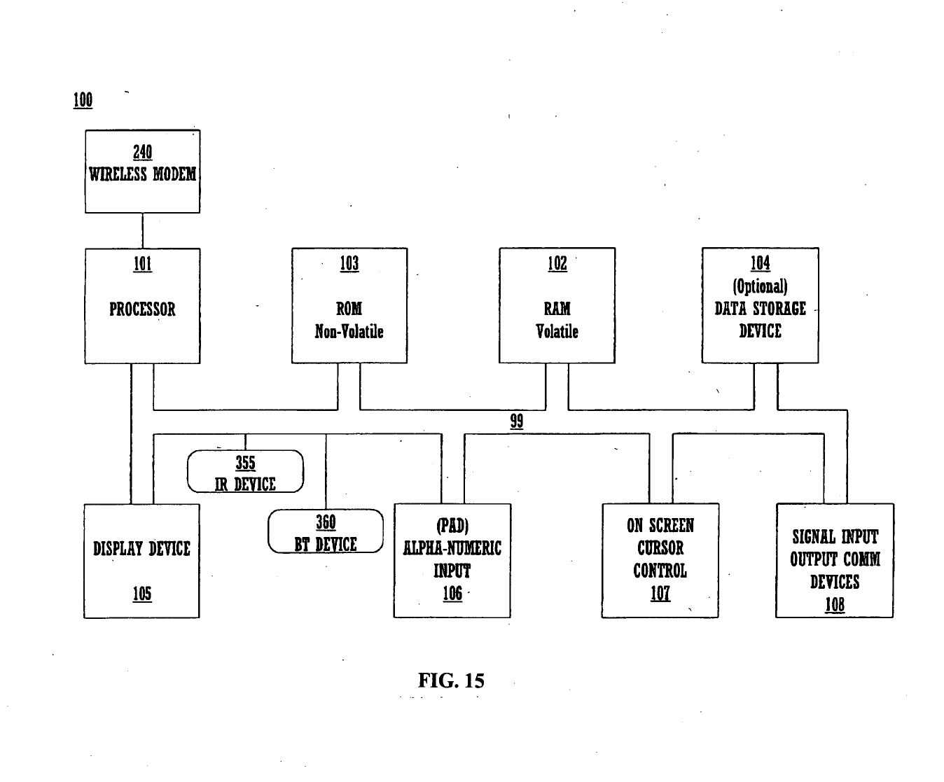

The touch screen can be a digitizer. A battery 215 provides electrical power. Replaceable cells or rechargeable batteries can be used. Well known electronics coupled to the battery 215 can detect the energy level of the battery 215. This information can be sampled by the computer system 110 (FIG. 15) using well known techniques. The digitizer of FIG. 3 can be implemented using well known devices, for instance, using the ADS-7846 device by Burr-Brown that provides separate channels for spatial stroke information and pressure information. A contrast adjustment (potentiometer) 220 is also shown but can also be implemented electronically, e.g., by software, (FIG. 12) without any manual knob. On/off button 95 is shown along with an infrared emitter and detector device 64. A flex circuit 230 is shown along with a PC board 225 containing electronics and logic (e.g., memory, communication bus, processor, etc.) for implementing computer system functionality. The digitizer pad is also included in PC board 225. A midframe 235 is shown along with stylus 80. Optional position adjustable antenna 85 is shown. The midframe 235 contains the stylus receiving slot or rail 350.

An optional radio receiver/transmitter device 240 is also shown between the midframe and the rear cover 245 of FIG. 13. Device 240 may include a wireless modem device and/or a wireless radio, e.g., a GSM wireless radio with supporting chipset. The receiver/transmitter device 240 is coupled to the antenna 85 and also coupled to communicate with the PC board 225. In one implementation, the Mobitex wireless communication system is used to provide two way communication between system 100 and other networked computers and/or the Internet via a proxy server. In other embodiments, TCP protocol can be used. The wireless communication capability of system 100 can be implemented using a number of well known technologies, such as, for instance, cellular phone technology, Bluetooth, wireless LAN (e.g., 802.11), etc.

FIG. 14 is a perspective illustration of one embodiment of the cradle 60 for receiving the palmtop computer system 100. In other embodiments, cradle 60 is not a stand-up device but is rather part of a cable connection between the palmtop computer system 100 and the desk top unit. Cradle 60 contains a mechanical and electrical interface 260 for interfacing with serial connection 108 (FIG. 11) of computer system 100 when system 100 is slid into the cradle 60 in an upright position. Alternatively, a USB connection could be used. Once inserted, button 270 may be pressed to initiate two way communication between system 100 and other computer systems coupled to serial communication 265.

FIG. 15 illustrates circuitry of palmtop computer system 100, some of which can be implemented on PC board 225. Computer system 100 includes an address/data bus 99 for communicating information, a central processor 101 coupled with the bus 99 for processing information and instructions, a volatile memory 102 (e.g., random access memory RAM) coupled with the bus 99 for storing information and instructions for the central processor 101 and a non-volatile memory 103 (e.g., read only memory ROM) coupled with the bus 99 for storing static information and instructions for the processor 101. Computer system 110 also includes an optional data storage device 104 (e.g., thin profile removable memory) coupled with the bus 99 for storing information and instructions. Device 104 can be removable. As described above, system 100 also contains a display device 105 coupled to the bus 99 for displaying information to the computer user. PC board 225 can contain the processor 101, the bus 99, the ROM 103 and the RAM 102.

Also included in computer system 110 of FIG. 15 is an alphanumeric input device 106 which in one implementation is a handwriting recognition pad (“digitizer”) having regions 106a and 106b (FIG. 10), for instance. Device 106 can communicate information (spatial data and pressure data) and command selections to the central processor 101. System 110 also includes an optional cursor control or directing device 107 coupled to the bus for communicating user input information and command selections to the central processor 101. In one implementation, device 107 is a touch screen device incorporated with screen 105. Device 107 is capable of registering a position on the screen 105 where the stylus makes contact and the pressure of the contact. The display device 105 utilized with the computer system 110 may be a liquid crystal device, cathode ray tube (CRT), field emission device (FED, also called flat panel CRT) or other display device suitable for creating graphic images and alphanumeric characters recognizable to the user. In one embodiment, the display 105 utilizes color sequential scanning but could also utilize color filters with subpixels.

Signal communication device 108, also coupled to bus 99, can be a serial port (or USB port) for communicating with the cradle 60. In addition to device 108, wireless communication links can be established between the device 100 and a host computer system using a Bluetooth wireless device 360 or an infrared device 355. The wireless modem device 240 is coupled to communicate with the processor 101 but is not directly coupled to port 108.

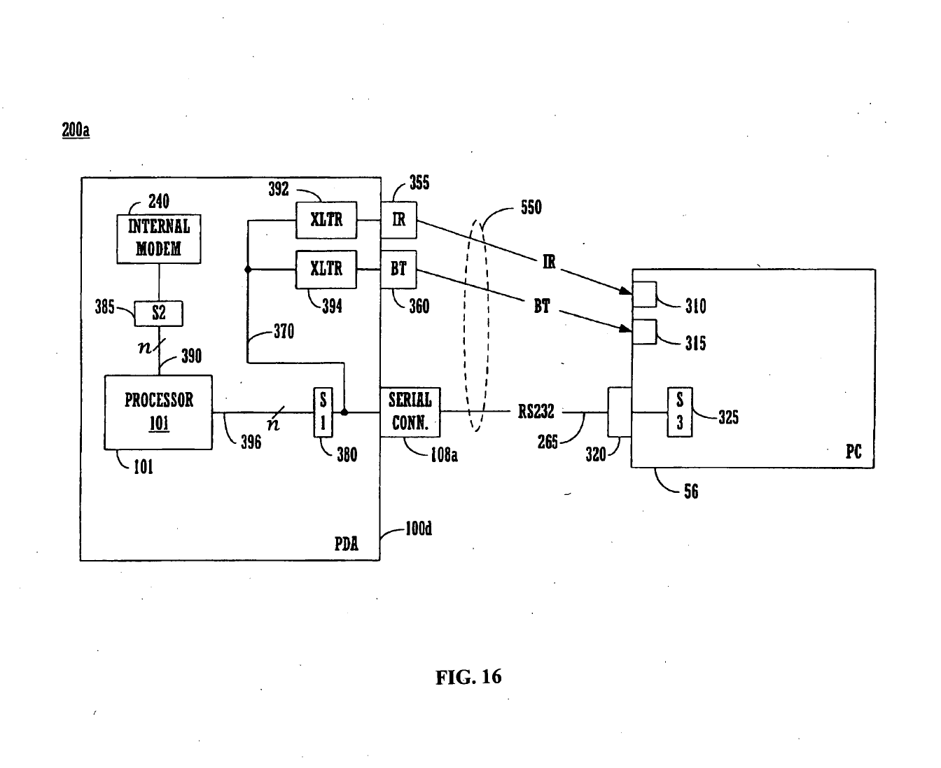

FIG. 16 illustrates a hardware diagram 200a in accordance with an embodiment of the present invention where a portable computer system 100d is used as a peripheral device to a connected host computer system 56. The portable computer system 100d may be communicatively linked to the host computer system 56 using one of a variety of different communication mechanisms 550. In one embodiment, a wired connection 265 is used, e.g., a serial communication (RS/232) or a USB connection may be used. Alternatively, the link 550 may be established using a wireless connection, e.g., Bluetooth or infrared communication may be used. To support wired connections, an external communication device or connector 108a is present on the outside surface of device 100d.

Different communication devices are used to support the different communication mechanisms available to establish link 550. To support Bluetooth connections, an external Bluetooth communication device 360 is present on the outside surface of device 100d which communicates with a corresponding device 315 on the host computer system 56. To support infrared connections, an external IR communication device 355 is present on the outside surface of device 100d which communicates with a corresponding device 310 on the host computer system 56. Host computer system 56 contains a communication port 325 which is directly connected to a serial communication device 320 which is connected to serial line 265. When device 100d is connected to the host computer system 56 using the serial line, connector 108a is coupled to line 265 (e.g., using the cradle 60). Serial port 325 may be a UART chip.

Portable device 100d of FIG. 16 also contains an internal resource, e.g., a wireless modem 240 (which could also be a wireless radio device) that is coupled to communicate with processor 101 over an internal serial port 385. Device 240 may also communicate over a wireless network for exchange of information. Serial port 385 is a communication port and is coupled to processor 101 using n-bit bus 390. In one embodiment, port 385 is a serial UART port of the well known type. It is appreciated that the serial port 385 is directly accessible by the processor 101 because the processor 101 is directly connected to the serial port 385. Therefore, the processor 101 may directly access the internal modem 240.

Portable device 100d of FIG. 16 also contains another communication port 380 that is externally accessible to the wired communication interface 108a, and the wireless communication devices 355 and 360. In one embodiment, the wireless communication devices 355 and 360 contain respective translators 392 and 394 for translating their communication protocols to a standard serial, communication protocol which exists at bus 370. In this way, the information on bus 370 is always presented according to the serial communication standard (e.g., RS/232) but could also be USB formatted. It is appreciated that the serial port 380 is directly connected to processor 101 by an n-bit bus 396. Port 380 may be a UART chip. In one embodiment, internal port 385 and externally accessible port 380 are serial communication ports. In this case, bus 390 and bus 396 each contain a respective transmit line (Tx) and a respective receive line (Rx) according to the well known RS/232 serial interface standard.

While the communication ports 380 and 385 are shown as separate devices and separate from processor 101, in one embodiment, the communication ports could also be integrated within the processor 101.

It is appreciated that regardless of the communication link used to establish communication link 550 between the device 100d and the host computer system 56, the internal communication port 385 is never directly connected to serial port 380. Therefore, the host computer system 56 is not able to directly access the internal modem 240 using the externally accessible port 380, according to the strict hardware design.

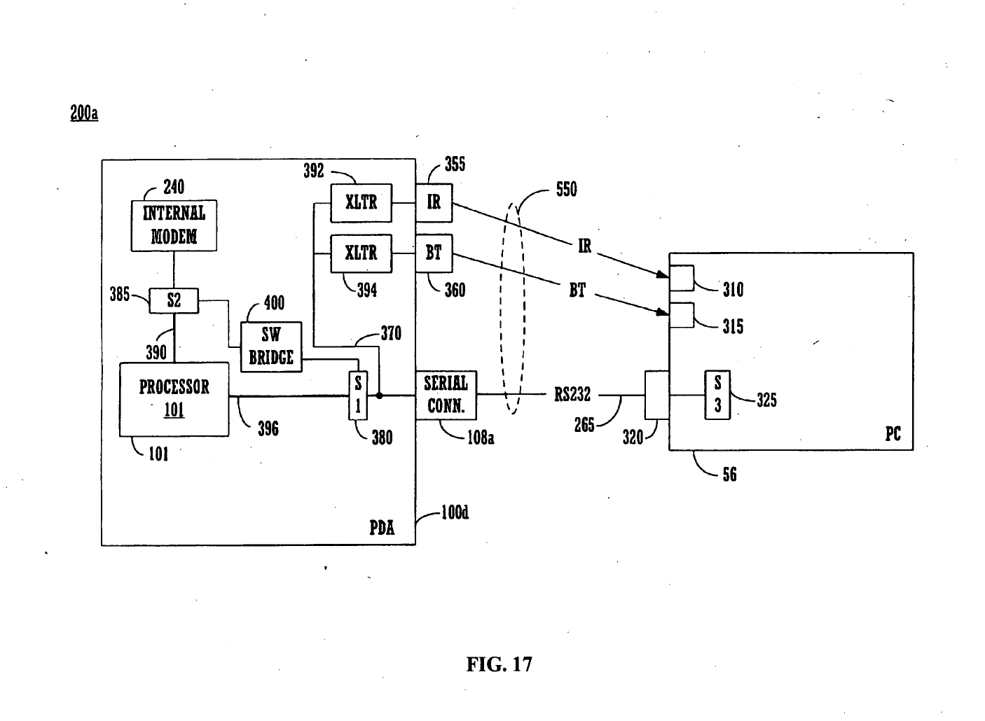

FIG. 17 illustrates system 200b including the bridge process 400 (or “software bridge” 400) in accordance with an embodiment of the present invention. The bridge process 400 is a software process implemented to bridge communications between externally accessible port 380 and internal port 385, as shown graphically in FIG. 17. By using the bridge process 400, the present invention is able to provide indirect, but transparent, communication between port 380 and port 385. The bridge process 400 therefore makes the internal modem 240 accessible to the host computer system 56 over communication link 550 via port 380. By making the internal wireless modem 240 accessible to the host computer system 56, the host computer system 56 can use the internal wireless modem 240 as a peripheral device, e.g., to connect to the Internet wirelessly.

An immediate attraction of using a wireless PDA 100d as a wireless modem is based, in part, on the fact that the PDA user probably already has all of the needed hardware. The interface is very user friendly because the PDA 100d is routinely connected to the host computer system 56 for synchronization. This same link can then be used for accessing the wireless modem 240 of the PDA 110d. In other words, unlike a wireless phone, PDAs generally come with a cable attachment to the host computer system 56. Any wireless PDA 100d in its cradle can then readily be used as a wireless modem by a host computer system 56 connected to the device 100d via some connection 550. This network is useful for most host computer systems and is especially valuable for laptops.

It is appreciated that the bridge process 400 need not be integrated into the operation system (OS) of device 100d, but could readily exist as a free standing application. Generally, the bridge process 400 may behave in one of two different modes. First, the PDA 100d may use a wireless radio 240 that looks like a modem (e.g., a GSM chipset) and the software 400 then acts as a bridge between the transport to the host computer system 56 and the transport to the modem 240 (e.g., a layer two bridge). Second, the PDA 100d may use a wireless radio that does not look like a modem (like certain GPRS chipsets). In these cases, the PDA 100d may act as a termination point for the PPP link to the host computer system 56. The PDA 100d may then perform translation of IP (layer 3) data from the PPP link to the link layer used by the radio device 240. These different scenarios are described further below.

FIG. 18 illustrates a flow diagram of steps 400 performed by processor 101 to implement the software bridge 400. It is appreciated that process 400 may be implemented as software code stored in computer readable memory units of device 100d and executed by processor 101. At step 405, if the bridge software is invoked, then step 410 is entered. Process 400 can be invoked automatically by detecting certain commands and/or data over communication link 550. Alternatively, process 400 can be invoked by a user launching the application from the OS.

At step 410, the processor 101 reads commands and data from the receive line (Rx) of the externally accessible communication port (Si) 380. At step 415, the processor 101 then relays or copies these commands and data to the transmit line (Tx) of the internal communication port (S2) 385. This supports the transparent flow of information from the host computer system 56 to the wireless modem 240. At step 420, the processor 101 reads commands and data from the receive line (Rx) of the communication port (S2) 385. At step 425, the processor 101 then relays or copies these commands and data to the transmit line (Tx) of the externally accessible communication port (S1) 380. This supports the transparent flow of information from the wireless modem 240 to the host computer system 56.

At step 430, if the bridge software is maintained, then step 410 is executed again. If not, then process 400 returns and the software enabled communication link between ports 385 and 380 is terminated.

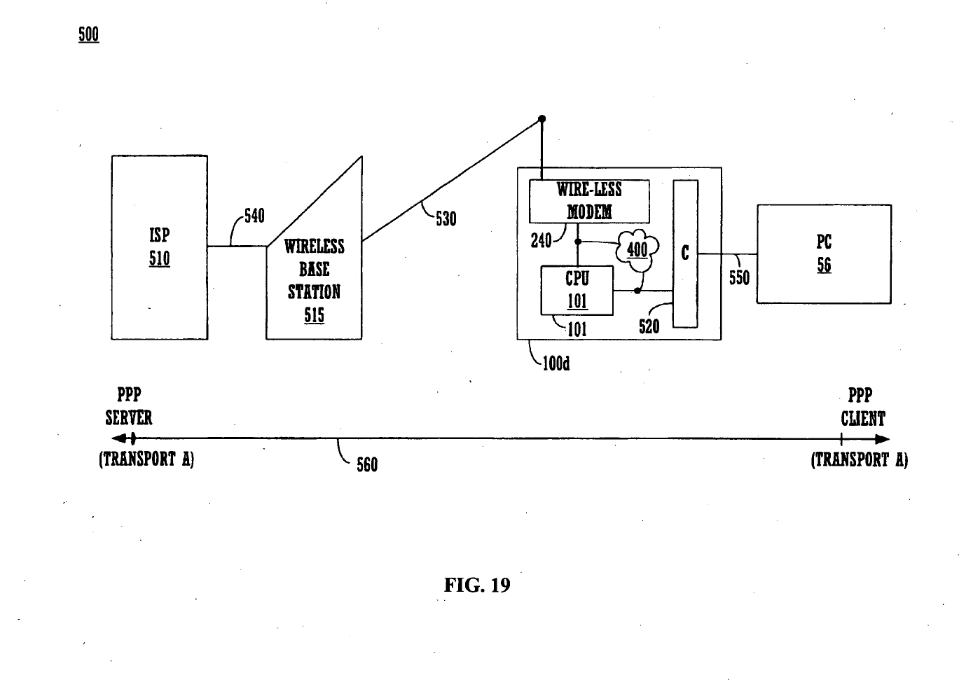

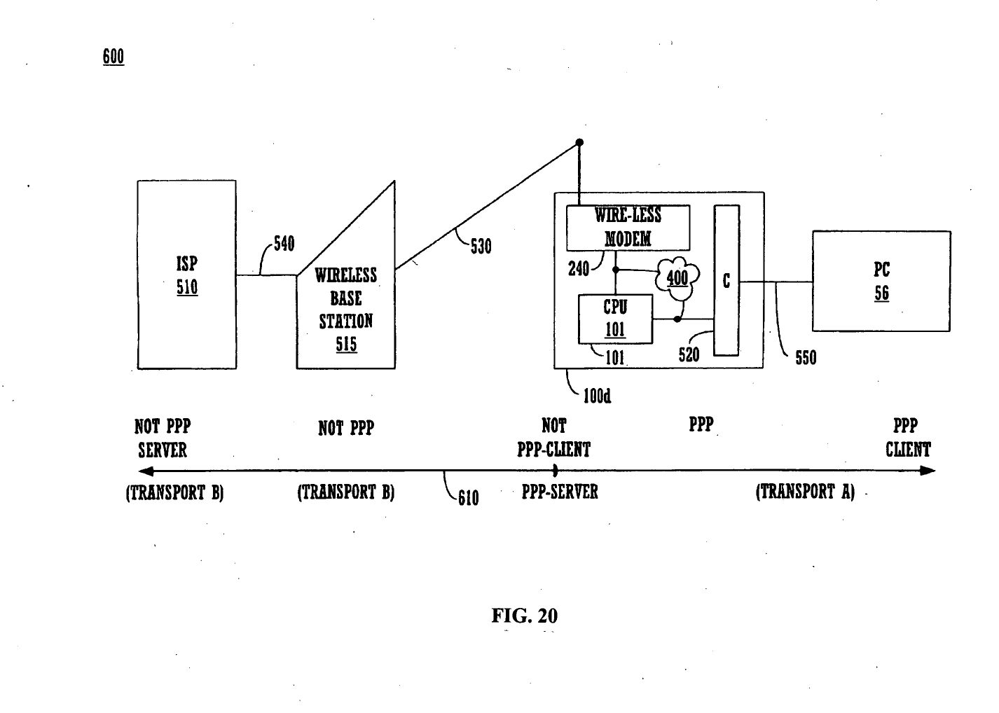

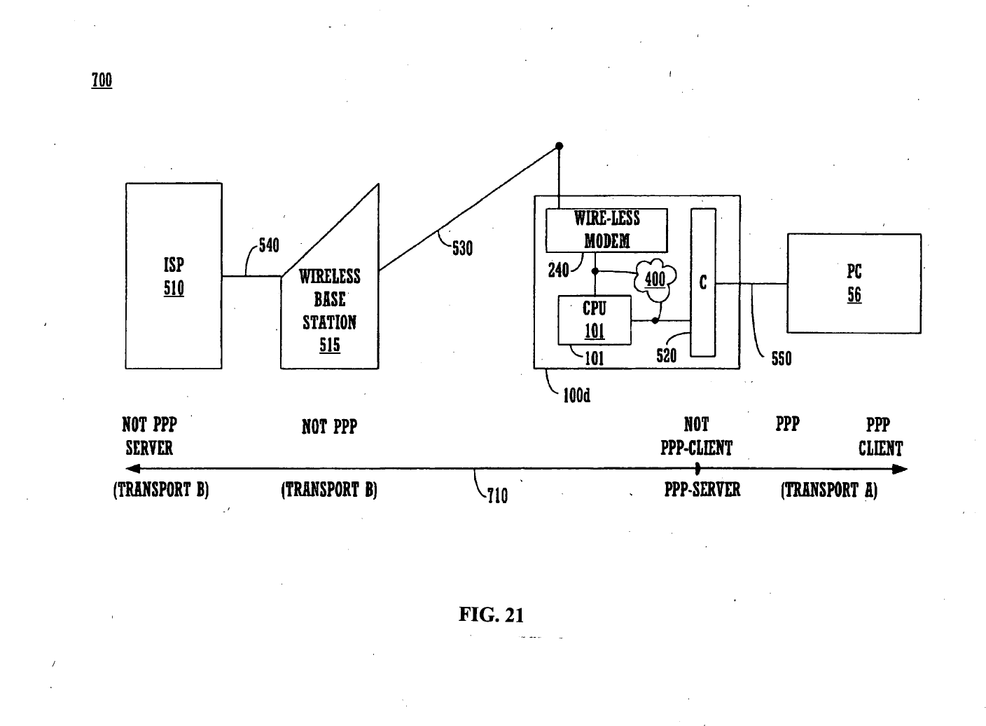

FIG. 19, FIG. 20 and FIG. 21 illustrate different protocol diagrams in which no transport translation is required, in which modem transport translation is required and in which the software bridge performs the transport translation. It is appreciated that the embodiments of the present invention described in FIG. 19, FIG. 20 and FIG. 21 are applicable between any two transports, e.g., transport A and transport B. For sake of discussion, PPP-transport (transport A) and non-PPP transport (transport B) have been selected as examples only. Other transports could be used, e.g., SLIP and many well known others.

FIG. 19 illustrates a communication environment 500 in which embodiments of the present invention may operate. Communication network 500 is transport A, e.g., PPP (point-to-point protocol) end-to-end, in that a PPP server 510 communicates to a PPP client 56. This is shown in the protocol legend 560. In this network, a PDA 100d is coupled as a wireless modem peripheral to a host computer system 56 using a link 550. An Internet service provide (ISP) 510 acts as the PPP server which communicates over a physical link 540 to a wireless base station 515. Base station 515 wirelessly communicates 530 to the wireless modem 240 inside device 100d. Wireless modem 240 is PPP compliant and therefore no transport translation is required. Software bridge 400 maintains a transparent link between the internal port of the wireless modem and the externally accessible connection 520 (e.g., IR 355, BT 360 or serial 108a). This is done using PPP. A link 550 then carries commands and data to the host computer system 56 which is the PPP client.

FIG. 20 illustrates another communication environment 600 that is similar to environment 500 of FIG. 8 except that in environment 600 the ISP 510 and the wireless base station 515 are not PPP compliant, as shown by the protocol legend 610. A transport B, e.g., non-PPP transport, for example, is WCDMA. In this case, the device 100d is not a PPP client. Therefore, the modem 240 performs a translation between the non-PPP transport received over wireless link 530 and a PPP compliant transport supplied to the software bridge 400 (and vice-versa). This translation is well known. As a result, the device 100d acts a PPP server. A PPP compliant transport is then supplied over link 550 to the host computer 56 which acts a PPP client.

FIG. 21 illustrates another communication environment 700 that is similar to environment 600 of FIG. 9 except that the software bridge 400 performs the required translation, not the wireless modem 240. This translation is well known. The modem 240 is therefore fully PPP non-compliant (e.g., is transport B complaint). The resulting protocol legend 710 is shown. In this case, the device 100d is transport B compliant, e.g., not a PPP client. Therefore, the software bridge 400 performs a translation between the non-PPP transport received from the modem 240 and a PPP compliant transport supplied over link 550 (and vice-versa). As a result, the device 100d acts a PPP server. A PPP compliant transport is then supplied over link 550 to the host computer 56 which acts a PPP client.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

What is claimed is:

1. A mobile computing device, comprising:
a display;
a first transceiver to communicate with a fixed wireless device;
a second transceiver to communicate with multiple wireless devices; and
a module to manage communications between the multiple wireless devices and the fixed wireless device.

2. The mobile computing device of claim 1, wherein the mobile computing device is small enough to be held in the hand of a user and further comprises a touch screen.

3. The mobile computing device of claim 1, wherein the mobile computing device is configured to provide at least one of account crediting and account debiting information to an accounting system based on the communications between the multiple wireless devices and the fixed wireless device.

4. The mobile computing device of claim 1, wherein the processor is configured to operate a bridge process to bridge communications between the first transceiver and second transceiver.

5. The mobile computing device of claim 1, further comprising:
an antenna;
a radio sub-system to couple to the antenna, the radio sub-system comprising the first and second transceivers;
a processing sub-system to execute the module; and
a bus coupled between the radio sub-system and processing sub-system.

6. The mobile computing device of claim 1, the module to discover each wireless device, and form a separate data connection with each wireless device, the first transceiver to communicate with the fixed wireless device using a first communication protocol and the second transceiver to communicate with the wireless devices using a second communication protocol.

7. The mobile computing device of claim 1, the module to control access to a shared wireless media by the wireless devices to communicate information with the fixed wireless device.

8. A portable computing device, comprising:
a display;
a first transceiver to communicate with a fixed wireless access point;
a second transceiver to communicate with a plurality of wireless devices; and
a circuit to provide communications between the plurality of wireless devices and the fixed wireless access point.

9. The portable computing device of claim 8, wherein the portable computing device is small enough to be held in the hand of a user and further comprises a touch screen.

10. The portable computing device of claim 8, wherein the portable computing device is configured to provide at least one of account crediting and account debiting information to an accounting system based on the communications between the plurality of wireless devices an the fixed wireless access point.

11. The portable computing device of claim 8, wherein the circuit is configured to operate a bridge process to bridge communications between the first transceiver and second transceiver.

12. The portable computing device of claim 8, further comprising:
an antenna;
a radio sub-system to couple to the antenna, the radio sub-system comprising the first and second transceivers;
a processing sub-system to execute the module; and
a bus coupled between the radio sub-system and processing sub-system.

13. The portable computing device of claim 8, wherein the first transceiver is configured to communicate over a cellular radio system and the second transceiver is configured to communicate over a wireless local area network system.

14. The portable computing device of claim 8, wherein the portable computing device is configured to act as a repeater for data transmitted between the plurality of wireless devices and the fixed wireless access point.

15. A portable computer, comprising:
a display;
a first transceiver to communicate wirelessly with a server;
a second transceiver to communicate with a plurality of computers; and
a processor to provide communications between the plurality of computers and the server.

16. The portable computer of claim 15, wherein the portable computer is small enough to be held in the hand of a user and further comprises a touch screen.

17. The portable computer of claim 15, wherein the portable computer is configured to provide at least one of account crediting and account debiting information to an accounting system based on the communications between the plurality of computers and the server.

18. The portable computer of claim 15, wherein the processor is configured to operate a bridge process to bridge communications between the first transceiver and the second transceiver.

19. The portable computer of claim 15, further comprising:
an antenna;
a radio sub-system to couple to the antenna, the radio sub-system comprising the first and second transceivers;
a processing sub-system to execute the module; and
a bus coupled between the radio sub-system and processing sub-system.

20. The portable computer of claim 15, wherein the first transceiver is configured to communicate over a cellular phone network and the second transceiver is configured to communicate over a wireless local area network system.
